(19) United States
(12) Patent Application Publication
(10) Pub. No.: US 2025/0378646 A1
(43) Pub. Date: Dec. 11, 2025

(54) SYSTEMS AND METHODS FOR GENERATING A VIRTUAL REPRESENTATION OF REAL-WORLD OBJECTS

(71) Applicant: Apple Inc., Cupertino, CA (US)

(72) Inventors: Zachary Z. BECKER, Issaquah, WA (US); Michael P. JOHNSON, Sunnyvale, CA (US); Thorsten GERNOTH, San Francisco, CA (US)

(21) Appl. No.: 19/222,417

(22) Filed: May 29, 2025

Related U.S. Application Data
(60) Provisional application No. 63/656,526, filed on Jun. 5, 2024.

(51) Int. Cl. G06T 19/00; G06T 13/20

(52) U.S. Cl. CPC G06T 19/00; G06T 13/20

(57) ABSTRACT

In some examples, an electronic device presents a user interface for generating a virtual representation of one or more physical objects of a three-dimensional environment. In some examples, while presenting a first view of the three-dimensional environment, the electronic device initiates a capture process for generating a virtual representation of at least a portion of the one or more physical objects. In some examples, the electronic device presents a virtual reticle in the three-dimensional environment in response to initiating the capture process. In some examples, the electronic device presents the virtual reticle at an orientation and/or location in the three-dimensional environment corresponding to a feature of a surface targeted by the virtual reticle.

### CROSS REFERENCE TO RELATED APPLICATIONS

This application claims the benefit of U.S. Provisional Application No. 63/656,526, filed Jun. 5, 2024, the content of which is herein incorporated by reference in its entirety for all purposes.

### FIELD OF THE DISCLOSURE

This relates generally to user interfaces that enable a user to scan real-world objects using an electronic device.

### BACKGROUND OF THE DISCLOSURE

Extended reality environments are environments where at least some objects displayed for a user's viewing are generated using an electronic device. A user may create virtual representations that are based on physical objects to insert into extended reality environments.

### SUMMARY OF THE DISCLOSURE

Some examples of the disclosure are directed to systems and methods for generating a virtual representation of one or more physical (e.g., real-world) objects of a three-dimensional environment. In some examples, the electronic device generates the virtual representation of the one or more physical objects using one or more captured images. In some examples, the one or more images are captured in an “unbounded mode” of object capture while the electronic device is moved (e.g., by a user of the electronic device) in the three-dimensional environment. For example, during the unbounded mode of object capture, the contents of the virtual representation that is captured are not restricted to a pre-defined region of the three-dimensional environment, which enables the user to control the contents of the virtual representation dynamically during the image capture process. Additionally, a region of the three-dimensional environment does not need to be defined prior to capture, which improves the user experience by requiring fewer user inputs to enable capture and generation of a virtual representation. During unbounded object capture, the user of the electronic device captures images of a plurality of surfaces and/or objects in the three-dimensional environment, such that a virtual representation may be generated of the plurality of surface and/or objects.

In some examples, the electronic device presents a user interface for generating a virtual representation in the unbounded mode of object capture. In some examples, while presenting a first view of the three-dimensional environment including the one or more physical objects, the electronic device initiates a capture process for generating a virtual representation of at least a portion of the one or more physical objects. In some examples, in response to initiating the capture process, in accordance with a determination that one or more criteria are satisfied, the electronic device presents a first virtual reticle in the three-dimensional environment corresponding to a first feature (e.g., position, orientation, etc.) of a first surface targeted by the first virtual reticle.

In some examples, the one or more criteria include a criterion that is satisfied when the first surface is within a range of distances from the electronic device in the three-dimensional environment. In some examples, in response to initiating the capture process, and in accordance with the determination that the one or more criteria are satisfied, the electronic device presents the first virtual reticle at a first location in the three-dimensional environment corresponding to the first surface targeted by the first virtual reticle. For example, the first virtual reticle is presented on (e.g., snapped to) or in proximity to the first surface.

In some examples, while presenting a second view of the three-dimensional environment, different from the first view, during the capture process, the electronic device presents the first virtual reticle at a second orientation, different from the first orientation, corresponding to a second feature of a second surface targeted by the first virtual reticle. In some examples, while presenting the second view of the three-dimensional environment during the capture process, the electronic device presents the first virtual reticle at a second location, different from the first location, in the three-dimensional environment corresponding to the second surface targeted by the first virtual reticle. For example, the second virtual reticle is presented on (e.g., snapped to) or in proximity to the second surface.

Some examples of the disclosure are directed to systems and methods for presenting a preview of the virtual representation of the one or more physical objects during the capture process. In some examples, the preview of the virtual representation is a point cloud preview. For example, the preview is presented on a virtual object (e.g., a virtual platter having a circular shape) and/or within a virtual volume in the user interface (e.g., a hemi-ellipsoid or hemi-sphere). In some examples, while capturing one or more images of the one or more physical objects during the capture process in the unbounded mode of object capture, the electronic device updates the preview of the virtual representation. In some examples, the electronic device presents an animation while updating the preview. For example, the electronic device presents a pulse and/or wave that propagates (e.g., outward from the center of the hemi-ellipsoid or hemi-sphere) through the preview (and/or the virtual object the preview is displayed on and/or the virtual volume the preview is displayed within) while updating the preview.

The full descriptions of the examples are provided in the Drawings and the Detailed Description, and it is understood that this Summary does not limit the scope of the disclosure in any way.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 illustrates an example object scanning process in accordance with some examples of the disclosure.

FIG. 2 illustrates block diagrams of exemplary architectures for devices according to some examples of the disclosure.

FIGS. 3A-3O illustrate examples of an electronic device presenting user interfaces for generating a virtual representation of one or more physical objects of a three-dimensional environment, according to examples of the disclosure.

FIG. 4 illustrates a flow diagram for a method of initiating a capture process for generating a virtual representation of one or more physical objects, according to examples of the disclosure.

### DETAILED DESCRIPTION

Some examples of the disclosure are directed to systems and methods for generating a virtual representation of one or more physical (e.g., real-world) objects of a three-dimensional environment. In some examples, the electronic device generates the virtual representation of the one or more physical objects using one or more captured images. In some examples, the one or more images are captured in an “unbounded mode” of object capture while the electronic device is moved (e.g., by a user of the electronic device) in the three-dimensional environment. For example, during the unbounded mode of object capture, the contents of the virtual representation that is captured are not restricted to a pre-defined region of the three-dimensional environment, which enables the user to control the contents of the virtual representation dynamically during the image capture process. Additionally, a region of the three-dimensional environment does not need to be defined prior to capture, which improves the user experience by requiring fewer user inputs to enable capture and generation of a virtual representation. During unbounded object capture, the user of the electronic device captures images of a plurality of surfaces and/or objects in the three-dimensional environment, such that a virtual representation may be generated of the plurality of surface and/or objects. Although primarily referred to herein as “unbounded mode” of object capture and “bounded mode” of object capture, these two modes can be alternatively referred to as an “area mode” of capture and an “object mode” of capture because the goal of the latter is to capture an object and the goal of the former can be broader than capture of an object.

In some examples, the electronic device presents a user interface for generating a virtual representation in the unbounded mode of object capture. In some examples, while presenting a first view of the three-dimensional environment including the one or more physical objects, the electronic device initiates a capture process for generating a virtual representation of at least a portion of the one or more physical objects. In some examples, in response to initiating the capture process, in accordance with a determination that one or more criteria are satisfied, the electronic device presents a first virtual reticle in the three-dimensional environment corresponding to a first feature (e.g., position, orientation, etc.) of a first surface targeted by the first virtual reticle.

In some examples, the one or more criteria include a criterion that is satisfied when the first surface is within a range of distances from the electronic device in the three-dimensional environment. In some examples, in response to initiating the capture process, and in accordance with the determination that the one or more criteria are satisfied, the electronic device presents the first virtual reticle at a first location in the three-dimensional environment corresponding to the first surface targeted by the first virtual reticle. For example, the first virtual reticle is presented on (e.g., snapped to) or in proximity to the first surface.

In some examples, while presenting a second view of the three-dimensional environment, different from the first view, during the capture process, the electronic device presents the first virtual reticle at a second orientation, different from the first orientation, corresponding to a second feature of a second surface targeted by the first virtual reticle. In some examples, while presenting the second view of the three-dimensional environment during the capture process, the electronic device presents the first virtual reticle at a second location, different from the first location, in the three-dimensional environment corresponding to the second surface targeted by the first virtual reticle. For example, the second virtual reticle is presented on (e.g., snapped to) or in proximity to the second surface.

Some examples of the disclosure are directed to systems and methods for presenting a preview of the virtual representation of the one or more physical objects during the capture process. In some examples, the preview of the virtual representation is a point cloud preview. For example, the preview is presented on a virtual object (e.g., a virtual platter having a circular shape) and/or within a virtual volume in the user interface (e.g., a hemi-ellipsoid or hemi-sphere). In some examples, while capturing one or more images of the one or more physical objects during the capture process in the unbounded mode of object capture, the electronic device updates the preview of the virtual representation. In some examples, the electronic device presents an animation while updating the preview. For example, the electronic device presents a pulse and/or wave that propagates (e.g., outward from the center of the hemi-ellipsoid or hemi-sphere) through the preview (and/or the virtual object the preview is displayed on and/or the virtual volume the preview is displayed within) while updating the preview.

In the following description of examples, reference is made to the accompanying drawings which form a part of this Specification, and in which it is shown by way of illustration, specific examples that are within the scope of the present disclosure. It is to be understood that other examples are also within the scope of the present disclosure and structural changes can be made without departing from the scope of the disclosure.

As used herein, the phrases “the,” “a,” and “an” include both the singular forms (e.g., one element) and plural forms (e.g., a plurality of elements), unless explicitly indicated or the context indicates otherwise. The term “and/or” encompasses any and all possible combinations of the listed items (e.g., including examples that include none of some of the listed items). The terms “comprises,” and/or “includes,” specify the inclusion of stated elements, but do not exclude the addition of other elements (e.g., the existence of other elements that are not explicitly recited in and of itself does not render an example from not “including” or “comprising” an explicitly recited element). As used herein, the terms “first,” “second,” etc. are used to describe various elements, but these terms should not be interpreted as limiting the various elements, and are used merely to distinguish one element from another (e.g., to distinguish two of the same type of element from each other). The term “if” can be interpreted to mean “when,” “upon” (e.g., optionally including a temporal element) or “in response to” (e.g., without requiring a temporal element).

Physical settings are those in the world where people can sense and/or interact without use of electronic systems (e.g., the real-world environment, the physical environment, etc.). For example, a room is a physical setting that includes physical elements, such as, physical chairs, physical desks, physical lamps, and so forth. A person can sense and interact with these physical elements of the physical setting through direct touch, taste, sight, smell, and hearing.

In contrast to a physical setting, an extended reality (XR) setting refers to a computer-produced environment that is partially or entirely generated using computer-produced content. While a person can interact with the XR setting using various electronic systems, this interaction utilizes various electronic sensors to monitor the person's actions, and translates those actions into corresponding actions in the XR setting. For example, if an XR system detects that a person is looking upward, the XR system may change its graphics and audio output to present XR content in a manner consistent with the upward movement. XR settings may incorporate laws of physics to mimic physical settings.

Concepts of XR include virtual reality (VR) and augmented reality (AR). Concepts of XR also include mixed reality (MR), which is sometimes used to refer to the spectrum of realities between physical settings (but not including physical settings) at one end and VR at the other end. Concepts of XR also include augmented virtuality (AV), in which a virtual or computer-produced setting integrates sensory inputs from a physical setting. These inputs may represent characteristics of a physical setting. For example, a virtual object may be displayed in a color captured, using an image sensor, from the physical setting. As another example, an AV setting may adopt current weather conditions of the physical setting.

Some electronic systems for implementing XR operate with an opaque display and one or more imaging sensors for capturing video and/or images of a physical setting. In some implementations, when a system captures images of a physical setting, and displays a representation of the physical setting on an opaque display using the captured images, the displayed images are called a video pass-through. Some electronic systems for implementing XR operate with an optical see-through display that may be transparent or semi-transparent (and optionally with one or more imaging sensors). Such a display allows a person to view a physical setting directly through the display, and allows for virtual content to be added to the person's field-of-view by superimposing the content over an optical pass-through of the physical setting (e.g., overlaid over portions of the physical setting, obscuring portions of the physical setting, etc.). Some electronic systems for implementing XR operate with a projection system that projects virtual objects onto a physical setting. The projector may present a holograph onto a physical setting, or may project imagery onto a physical surface, or may project onto the eyes (e.g., retina) of a person, for example.

Electronic systems providing XR settings can have various form factors. A smartphone or a tablet computer may incorporate imaging and display components to present an XR setting. A head-mountable system may include imaging and display components to present an XR setting. These systems may provide computing resources for generating XR settings, and may work in conjunction with one another to generate and/or present XR settings. For example, a smartphone or a tablet can connect with a head-mounted display to present XR settings. As another example, a computer may connect with home entertainment components or vehicular systems to provide an on-window display or a heads-up display. Electronic systems displaying XR settings may utilize display technologies such as LEDs, OLEDs, QD-LEDs, liquid crystal on silicon, a laser scanning light source, a digital light projector, or combinations thereof. Display technologies can employ substrates, through which light is transmitted, including light waveguides, holographic substrates, optical reflectors and combiners, or combinations thereof.

Examples of electronic devices, user interfaces for such devices, and associated processes for using such devices are described. In some examples, the device is a portable communications device, such as a mobile telephone, that also contains other functions, such as PDA and/or music player functions. Other portable electronic devices, such as laptops, tablet computers with touch-sensitive surfaces (e.g., touch screen displays and/or touch pads), or wearable devices, are, optionally, used. It should also be understood that, in some examples, the device is not a portable communications device, but is a desktop computer or a television with a touch-sensitive surface (e.g., a touch screen display and/or a touch pad). In some examples, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some examples, the device has a display, but is capable of receiving input information from a separate input device having one or more input mechanisms (such as one or more buttons, a touch screen display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

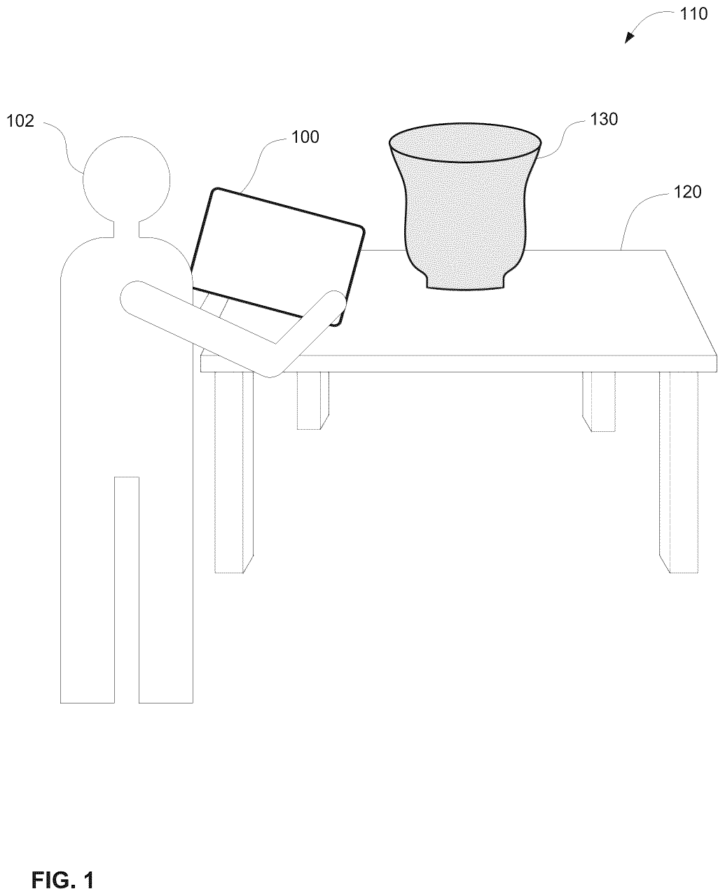

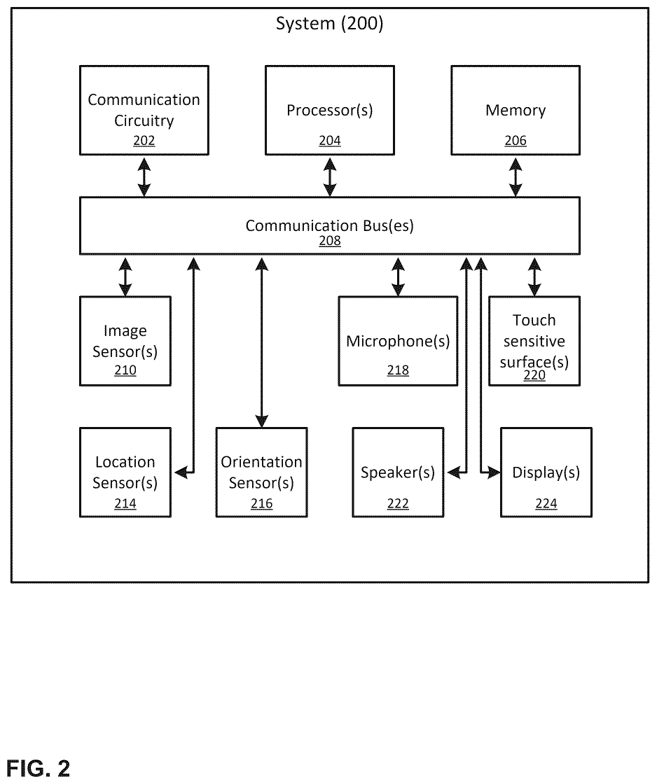

FIG. 1 illustrates user 102 and electronic device 100. In some examples, electronic device 100 is a hand-held or mobile device, such as a tablet computer or a smartphone. Examples of electronic device 100 are described below with reference to FIG. 2. As shown in FIG. 1, user 102 is located in the physical environment 110. In some examples, physical environment 110 includes table 120 and a physical object 130 positioned on top of table 120. In some examples, electronic device 100 may be configured to capture areas of physical environment 110. As will be discussed in more detail below, electronic device 100 includes one or more image sensor(s) that is configured to capture information about the objects in physical environment 110. In some examples, a user may desire to capture an object, such as physical object 130, and generate a virtual representation (e.g., a three-dimensional model) of physical object 130 (e.g., for use in an XR environment).

It should be appreciated that a user may desire to capture a plurality of objects (e.g., physical objects) of a three-dimensional environment. For example, the user may desire to generate a virtual representation (e.g., three-dimensional model) of a region of a three-dimensional environment that includes a plurality of objects (e.g., to create a three-dimensional model of a scene and/or landscape). For example, a user may desire to generate a virtual representation of a real-world environment, such as an outdoor location (e.g., the outdoor location includes trees, plants, rocks, etc.). The examples described herein describe systems and methods for capturing information about one or more physical (e.g., real-world) objects and generating a virtual representation of the one or more physical objects (e.g., to be used in an XR environment).

Attention is now directed toward examples of portable or non-portable devices with touch-sensitive displays, though the devices need not include touch-sensitive displays or displays in general, as described above. In some examples, the example devices are used to capture a set of images of one or more physical objects of a three-dimensional environment to generate a virtual representation. For example, a display of the device presents a user interface for one or more capture processes. The electronic device presents visual guidance to a user during the one or more capture processes, thereby reducing errors in capturing the set of images and/or generating the virtual representation of the one or more physical objects.

FIG. 2 illustrates a block diagrams of exemplary architectures for electronic device 200 in accordance with some examples. In some examples, electronic device 200 is a mobile device, such as a mobile phone (e.g., smart phone), a tablet computer, a laptop computer, an auxiliary device in communication with another device, etc. In some examples, as illustrated in FIG. 2, electronic device 200 includes various components, such as communication circuitry (202), processor(s) 204, memory (206), image sensor(s) 210, location sensor(s) 214, orientation sensor(s) 216, microphone(s) 218, touch-sensitive surface(s) (220), speaker(s) 222, and/or display(s) 224. These components optionally communicate over communication bus(es) 208 of electronic device 200.

Electronic device 200 includes communication circuitry 202. Communication circuitry 202 optionally includes circuitry for communicating with electronic devices, networks, such as the Internet, intranets, a wired network and/or a wireless network, cellular networks and wireless local area networks (LANs). Communication circuitry 202 optionally includes circuitry for communicating using near-field communication and/or short-range communication, such as Bluetooth®.

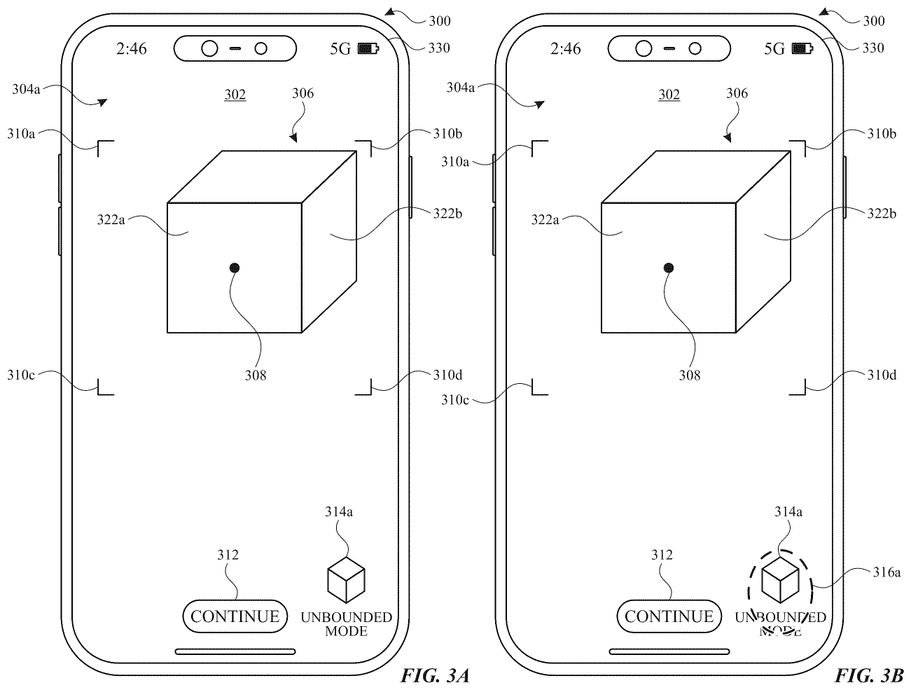

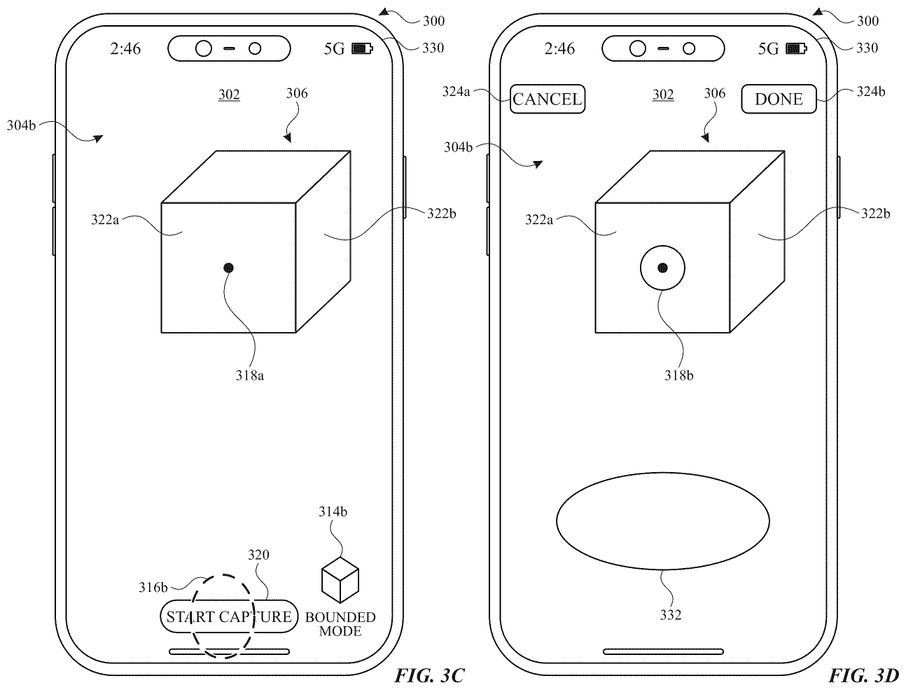

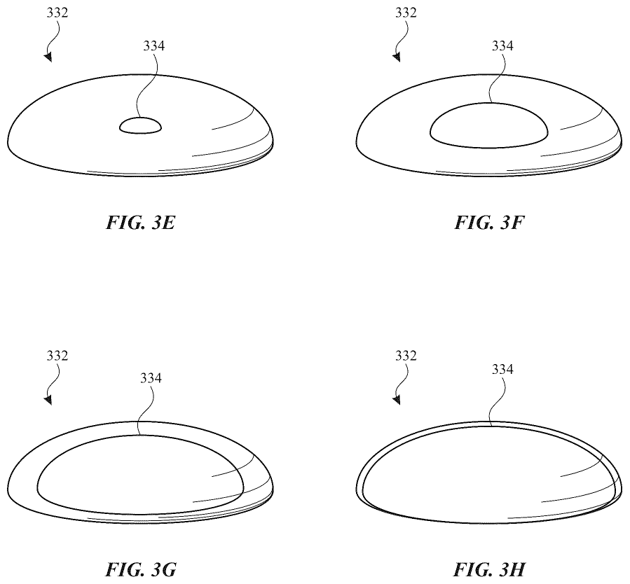

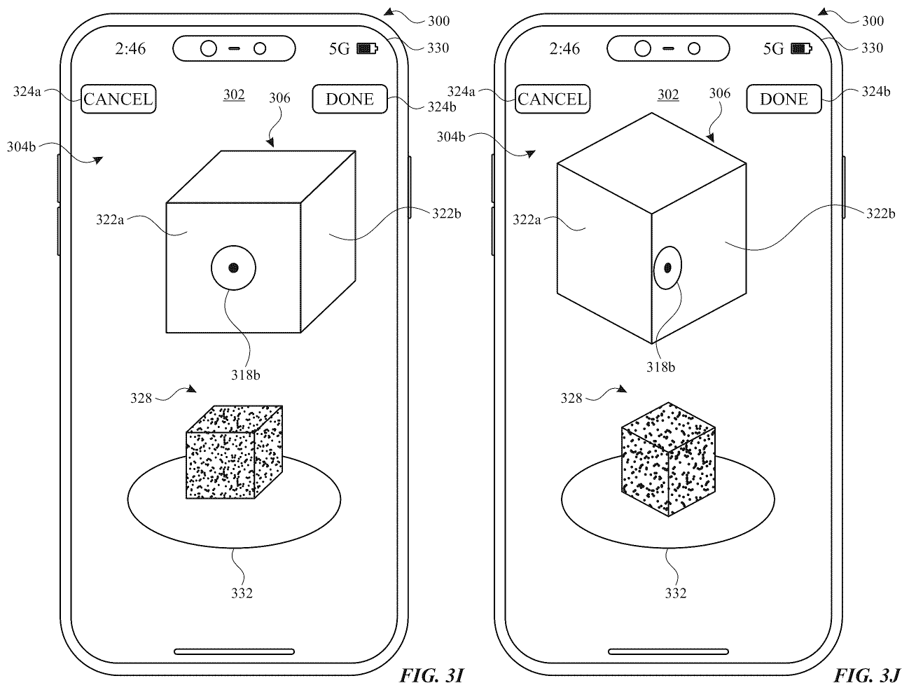

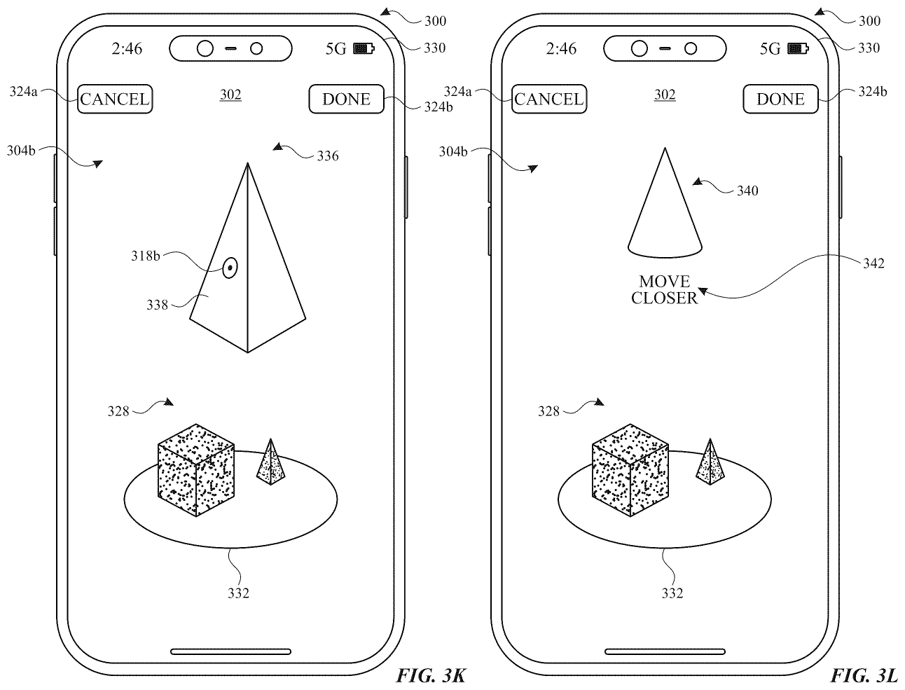

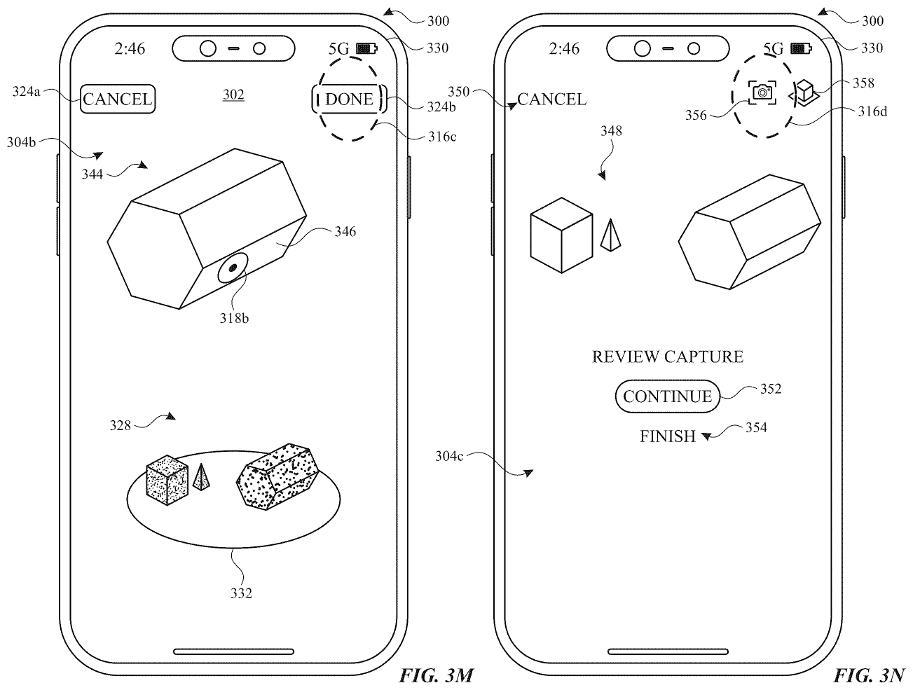

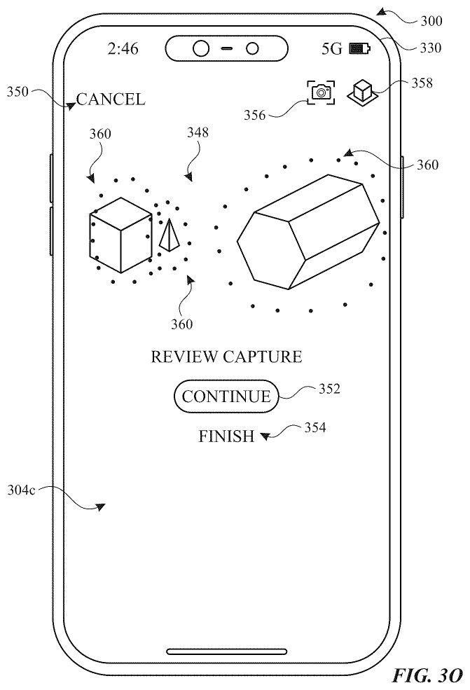

Processor(s) 204 include one or more general processors, one or more graphics processors, and/or one or more digital signal processors. In some examples, memory 206 are one or more non-transitory computer-readable storage mediums (e.g., flash memory, random access memory) that store computer-readable instructions configured to be executed by processor(s) 204 to perform the techniques, processes, and/or methods described below (e.g., with reference to FIGS. 3-7). A non-transitory computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

Electronic device 200 includes display(s) 224. In some examples, display(s) 224 include a single display. In some examples, display(s) 224 includes multiple displays. In some examples, electronic device 200 includes touch-sensitive surface(s) 220 for receiving user inputs, such as tap inputs and swipe inputs. In some examples, display(s) 224 and touch-sensitive surface(s) 220 form touch-sensitive display(s) (e.g., a touch screen integrated with electronic device 200 or external to electronic device 200 that is in communication with electronic device 200).

Electronic device 200 includes image sensor(s) 210 (e.g., capture devices). Image sensors(s) 210 optionally include one or more visible light image sensor, such as charged coupled device (CCD) sensors, and/or complementary metal-oxide-semiconductor (CMOS) sensors operable to obtain images of physical objects from the real environment. Image sensor(s) 210 also optionally include one or more infrared (IR) sensor(s), such as a passive IR sensor or an active IR sensor, for detecting infrared light from the real environment. For example, an active IR sensor includes an IR emitter, such as an IR dot emitter, for emitting infrared light into the real environment. Image sensor(s) 210 also optionally include one or more event camera(s) configured to capture movement of physical objects in the real environment. Image sensor(s) 210 also optionally include one or more depth sensor(s) configured to detect the distance of physical objects from electronic device 200. In some examples, information from one or more depth sensor(s) can allow the device to identify and differentiate objects in the real environment from other objects in the real environment. In some examples, one or more depth sensor(s) can allow the device to determine the texture and/or topography of objects in the real environment.

In some examples, electronic device 200 uses CCD sensors, event cameras, and depth sensors in combination to detect the physical environment around electronic device 200. In some examples, image sensor(s) 210 include a first image sensor and a second image sensor. The first image sensor and the second image sensor work in tandem and are optionally configured to capture different information of physical objects in the real environment. In some examples, the first image sensor is a visible light image sensor and the second image sensor is a depth sensor. In some examples, electronic device 200 uses image sensor(s) 210 to detect the position and orientation of electronic device 200 and/or display(s) 224 in the real environment. For example, electronic device 200 uses image sensor(s) 210 to track the position and orientation of display(s) 224 relative to one or more fixed objects in the real environment.

In some examples, electronic device 200 includes microphones(s) 218. Electronic device 200 uses microphone(s) 218 to detect sound from the user and/or the real environment of the user. In some examples, microphone(s) 218 includes an array of microphones (including a plurality of microphones) that optionally operate in tandem, such as to identify ambient noise or to locate the source of sound in space of the real environment.

Electronic device 200 includes location sensor(s) 214 for detecting a location of electronic device 200 and/or display(s) 224. For example, location sensor(s) 214 can include a GPS receiver that receives data from one or more satellites and allows electronic device 200 to determine the device's absolute position in the world.

Electronic device 200 includes orientation sensor(s) 216 for detecting orientation and/or movement of electronic device 200 and/or display(s) 224. For example, electronic device 200 uses orientation sensor(s) 216 to track changes in the position and/or orientation of electronic device 200 and/or display(s) 224, such as with respect to physical objects in the real environment. Orientation sensor(s) 216 optionally include one or more gyroscopes and/or one or more accelerometers.

Electronic device 200 is not limited to the components and configuration of FIG. 2, but can include other or additional components in multiple configurations.

Attention is now directed towards examples of user interfaces (“UI”) and associated processes that are implemented on an electronic device, such as electronic device 100, electronic device 200, or electronic device 300. The examples described below provide ways in which an electronic device generates a virtual representation of one or more physical objects of a physical environment. In some examples, the one or more physical objects are included in a three-dimensional environment that is presented via a display of the electronic device. The examples herein improve user device interaction while generating the virtual representation by permitting a user to capture images of one or more physical objects included in a three-dimensional environment through an unbounded mode of object capture. In the unbounded mode of object capture, the user is not restricted to a pre-defined region of the three-dimensional environment during the capture process, which enables the user to control what objects (and/or portions of objects) to include in the generated virtual representation (e.g., using the one or more images captured during the capture process). During the capture process, the electronic device presents visual guidance (via a display of the electronic device), which limits errors in capturing the images of the one or more objects and conserves computing resources associated with correcting errors.

As described below, an electronic device can include various user interfaces to facilitate the capturing of a set of images that are used to generate a virtual representation of one or more physical objects. Although the examples of FIGS. 3A-3O include user interfaces shown on a display of a hand-held device such as a cell phone, the user interfaces described herein are optionally implemented on a different type of electronic device, such as a head-mounted device (e.g., a headset used for presenting XR environments to a user), a smart watch, a tablet, a laptop, or another type of electronic device.

FIGS. 3A-3O illustrate examples of an electronic device presenting user interfaces for generating a virtual representation of one or more physical objects of a three-dimensional environment, according to examples of the disclosure.

FIG. 3A illustrates a first object capture user interface 304a for capturing one or more images of a physical object. User interface 304a is optionally presented (e.g., displayed) on a display of an electronic device 300, which optionally has one or more characteristics of electronic devices 100 and/or 200 shown and described with reference to FIGS. 1-2. User interface 304a is presented via a display 330 of electronic device 300. For example, display 330 has one or more characteristics of display(s) 224 shown and described with reference to FIG. 2. In some examples, display 330 is a touch-screen display.

As shown in FIG. 3A, user interface 304a includes a view of an environment 302. In some examples, environment 302 is a three-dimensional environment that is presented to a user of electronic device 300 (e.g., user 102 shown and described with reference to FIG. 1) via display 330. In some examples, environment 302 is an extended reality (XR) environment having one or more characteristics of an XR environment described above. For example, one or more virtual elements (e.g., computer-generated objects, such as virtual reticle 308) and/or physical objects (e.g., cube 306) of a physical environment of the user are included in the presented view of environment 302.

Alternatively, in some examples, user interface 304a is presented on a projection-based display (e.g., on a head-mounted device), or another type of display. For example, the view of environment 302 is viewed by a user wearing a head-mounted device (e.g., through a transparent and/or translucent display of a head-mounted device). For example, the view of environment 302 corresponds to a live view of a physical environment of a user (e.g., including one or more physical objects of the physical environment of the user) that is in the field of view of electronic device 300 (e.g., a region of the physical environment that is captured by one or more input devices of electronic device, such as image sensor(s) 210) and/or within the field of view of the user (e.g., if the user is wearing a head-mounted device).

As shown in FIG. 3A, user interface 304a includes a virtual reticle 308 (e.g., a dot) and a plurality of virtual elements 310a-310d. In some examples, electronic device 300 presents virtual reticle 308 and virtual elements 310a-310d overlaid on a current view of environment 302 (e.g., the current view of environment 302 includes cube 306). For example, virtual reticle 308 and virtual elements 310a-310d are presented at a fixed display position, such as horizontally centered and/or vertically centered (e.g., for the region of the display excluding the capture preview. For example, in response to movement of electronic device 300 that causes a changed view of environment 302, electronic device 300 maintains presentation of virtual reticle 308 and virtual elements 310a-310d at the same display location and orientation overlaid on the changed view of environment 302. In some examples, the reticle can be displayed as a two-dimensional object, and as though in the same plane as other user interface elements on the display (e.g., the time, battery status, user interface buttons, etc.).

In FIG. 3A, the presented view of environment 302 includes a cube 306. In some examples, cube 306 is a physical object included in the physical environment of the user of electronic device 300 (e.g., and is presented in environment 302 as pass-through of the physical environment). Although physical objects are shown as three-dimensional shapes (e.g., cube 306) in the figures for ease of illustration, it should be appreciated that environment 302 can include different types of objects that a user may desire to capture images (e.g., and generate virtual representations) of using electronic device 300 (e.g., objects included in outdoor physical settings (e.g., trees, rocks, plants, and/or man-made structures (e.g., benches)) or indoor physical settings (e.g., furniture, walls, doors, and/or ceilings)).

In some examples, electronic device 300 is configured to capture images (e.g., via image sensor(s) 210) of one or more physical objects through different capture processes. For example, user interface 304a shown in FIG. 3A is associated with a bounded mode of object capture. In the bounded mode of object capture, electronic device 300 optionally defines a region of environment 302 that will be included within the virtual representation generated during the capture process. Electronic device 300 optionally defines the region of environment 302 based on an object that is targeted by virtual reticle 308 (e.g., electronic device 300 defines the region of the environment 302 to a region occupied by the object). Additionally, or alternatively, electronic device 300 optionally defines the region of environment 302 based on an area and/or volume defined by virtual elements 310a-310d. For example, the region of environment 302 is defined based on the area of environment 302 that is included within virtual elements 310a-310d (e.g., from a current viewpoint of electronic device 300) when initiating the capture process (e.g., by selecting affordance 312). Optionally, the region of environment 302 is defined after initiating the capture process (e.g., after selection of affordance 312). For example, electronic device 300 transforms one or more of virtual elements 310a-310d into a three-dimensional virtual object (e.g., a box and/or cube) that defines the region of the environment 302 (e.g., the region of environment 302 included within the volume of the three-dimensional virtual object). Alternatively, or additionally, in some examples, electronic device 300 presents one or more selectable options within user interface 304a for a user of electronic device 300 to adjust the defined region of environment 302 after initiating the capture process and/or during the capture process.

In some examples, in the bounded mode of object capture, electronic device 300 presents visual guidance to assist a user of electronic device 300 in positioning electronic device 300 such that images are captured that are sufficient to generate an accurate virtual representation of cube 306. For example, electronic device 300 presents a visual indication (e.g., including text) to guide a user of electronic device 300 closer or farther from a respective object within the defined region of environment 302. For example, electronic device 300 presents a visual indication to guide a user of electronic device 300 to maintain an object and/or the defined region of environment 302 within a field of view of electronic device 300 (e.g., within a field of view of one or more image sensors (e.g., image sensor(s) 210 described above) of electronic device 300). For example, electronic device 300 presents a visual indication to guide a user of electronic device 300 to change a viewpoint of electronic device 300 relative to the defined region of environment 302 (e.g., to capture one or more images of a respective object and/or region of environment from one or more different angles).

In some examples, a user of electronic device 300 may not desire to be confined to a particular region of environment 302 during the capture process. For example, a user may desire to generate a virtual representation of a plurality of objects (e.g., as opposed to only cube 306) and/or capture aspects of an object with a shape that does not fit within the bounding volume (e.g., requires capturing too much of the environment around the object of interest due to the shape). Accordingly, in some examples, electronic device 300 is configured to capture images of one or more objects through an unbounded mode of object capture that is different from the bounded mode of object capture. For example, in the unbounded mode of object capture, electronic device 300 does not restrict the content of environment 302 that is captured for generation of the virtual representation to a pre-defined region of environment 302. During and/or after the capture process in the unbounded mode of object capture, electronic device 300 generates a virtual representation of the one or more physical objects.

In some examples, a user of electronic device 300 can select their preferred mode of object capture (e.g., the bounded mode of object capture and the unbounded mode of object capture are accessible through the same respective application on electronic device 300). In FIG. 3A, user interface 304a includes an affordance 314a that is selectable to switch from the bounded mode of object capture to the unbounded mode of object capture. In FIG. 3B, electronic device 300 detects selection of affordance 314a. As shown in FIG. 3B, a user of electronic device 300 performs a touch input 316a on display 330 corresponding to selection of affordance 314a. For example, touch input 316a is a tap input performed by an object (e.g., a finger of the user of electronic device 300) on display 330. Alternatively, in some examples, electronic device 300 switches from the bounded mode of object capture to the unbounded mode of object capture in response to a different type of user input, such as an audio input detected by microphone(s) 218 (e.g., a verbal command provided by the user of electronic device 300). Presenting affordance 314a in user interface 304a provides a user of electronic device 300 discretion to switch between the bounded and unbounded modes of object capture without requiring the user to exit the current application and/or access a different application (e.g., associated with the unbounded mode of object capture), which improves user device interaction (and conserves computing resources associated with requiring the user to access the bounded and unbounded modes of object capture through different applications).

In response to detecting selection of affordance 314a in FIG. 3B, electronic device 300 presents a second object capture user interface 304b in FIG. 3C. As shown in FIG. 3C, user interface 304b includes a virtual reticle 318a. In some examples, virtual reticle 318a includes one or more characteristics of virtual reticle 308 shown and described with reference to FIG. 3A. For example, virtual reticle 318a is presented by electronic device 300 overlaid on the current view of environment 302 at a fixed display position. In some examples, virtual reticle 318a is different from virtual reticle 308 (e.g., when changing from the bounded mode of object capture to the unbounded mode of object capture, electronic device 300 ceases to present virtual reticle 308 and presents virtual reticle 318a). In some examples, virtual reticle 318a corresponds to (e.g., is the same as) virtual reticle 308 (e.g., when changing from the bounded mode of object capture to the unbounded mode of object capture, electronic device 300 maintains display of virtual reticle 308). Further, as shown in FIG. 3C, changing from the bounded mode of object capture to the unbounded mode of object capture includes ceasing to present virtual elements 310a-310d (shown in FIGS. 3A-3B).

In FIG. 3C, user interface 304b includes an affordance 314b that is selectable to change from the unbounded mode of object capture to the bounded mode of object capture (e.g., in response to detecting selection of affordance 314a in FIG. 3B, electronic device 300 replaces the selection of affordance 314a with affordance 314b). For example, selection of affordance 314b has one or more characteristics of selection of affordance 314a shown and described with reference to FIG. 3B. In response to detecting selection of affordance 314b, electronic device 300 changes from the unbounded mode of object capture to the bounded mode of object capture and presents user interface 304a shown and described with reference to FIG. 3A (e.g., including presenting virtual reticle 308 and virtual elements 310a-310d).

User interface 304b further includes an affordance 320 that is selectable to initiate the capture process for the unbounded mode of object capture. In FIG. 3C, electronic device 300 detects selection of affordance 320. As shown in FIG. 3C, a user of electronic device 300 performs a touch input 316b on display 330 corresponding to selection of affordance 314a. In some examples, touch input 316b has one or more characteristics of touch input 316a shown and described with reference to FIG. 3B. Alternatively, in some examples, electronic device 300 initiates the capture process in response to a different type of user input, such as an audio input detected by microphone(s) 218 (e.g., a verbal command provided by the user of electronic device 300 corresponding to a request to initiate the capture process).

In response to detecting selection of affordance 320 in FIG. 3C, electronic device 300 initiates the capture process for the unbounded mode of object capture in FIG. 3D. As shown in FIG. 3D, a virtual reticle 318b is presented in environment 302. In some examples, virtual reticle 318b corresponds to virtual reticle 318a (shown in FIG. 3C). For example, in response to initiating the capture process for the unbounded mode of object capture, electronic device 300 transforms the presentation of virtual reticle 318a to virtual reticle 318b (e.g., by presenting an animation of virtual reticle 318a growing to the size to virtual reticle 318b, and/or by presenting an animation of virtual reticle 318a becoming a virtual object presented in environment 302 at a depth corresponding to the targeted surface 322a of cube 306). For example, virtual reticle 318a corresponds to a two-dimensional reticle presented in user interface 304b, and in response to initiating the capture process in the unbounded mode of object capture, electronic device 300 transforms virtual reticle 318a to a virtual and/or AR object (e.g., virtual reticle 318b shown in FIG. 3D) presented in environment 302 at a location and/or orientation corresponding to one or more features (e.g., depth (e.g., distance) from electronic device 300, orientation, and/or other physical surface features, such as ridges, curves, bumps, etc.) of targeted surface 322a of cube 306.

Virtual reticle 318b optionally corresponds to a virtual object (e.g., an augmented reality (AR) object) presented in environment 302. In some examples, virtual reticle 318b is not presented at a fixed display position (e.g., unlike virtual reticle 318a shown in FIG. 3C). For example, electronic device 300 presents virtual reticle 318b at different depths and/or orientations in environment 302. In some examples, while presenting virtual reticle 318b at different depths (e.g., relative to a Z-axis in environment 302) and/or orientations in environment 302, electronic device 300 maintains a fixed position of virtual reticle 318b relative to an X-axis (e.g., horizontal axis) and/or Y-axis (vertical axis) in environment 302 (e.g., from a current viewpoint of electronic device 300).

In some examples, electronic device 300 presents virtual reticle 318b at a depth in environment 302 corresponding to a respective surface (e.g., of a physical object in environment 302) virtual reticle 318b targets. For example, in FIG. 3D, electronic device 300 presents virtual reticle 318b at a depth corresponding to surface 322a of cube 306 (e.g., virtual reticle 318b is presented on and/or snapped to surface 322a, and/or at an offset distance in environment 302 in proximity to electronic device 300 and/or surface 322a, or at a distance that is a function (e.g., linear or non-linear) of the depth of surface 322a from electronic device 300). In some examples, in response to a change of view of electronic device 300 relative to environment 302, electronic device 300 changes the location of virtual reticle 318b in environment 302 based on the location (e.g., depth from electronic device 300) of the respective surface virtual reticle 318b currently targets (e.g., as shown and described with reference to FIG. 3K).

In some examples, electronic device 300 presents virtual reticle 318b at an orientation corresponding to one or more features (e.g., depth (e.g., from electronic device 300 in environment 302) and/or orientation (e.g., relative to environment 302)) of a respective surface virtual reticle 318b targets. For example, in FIG. 3D, electronic device 300 presents virtual reticle 318b at an orientation corresponding to the orientation of surface 322a (e.g., such that an orientation of virtual reticle 318b is parallel to an orientation of surface 322a). In some examples, in response to a change of view of electronic device 300 relative to environment 302, electronic device 300 changes the orientation of virtual reticle 318b based on the features of the respective surface virtual reticle 318b currently targets (e.g., as shown and described with reference to FIG. 3J). Presenting virtual reticle 318b as a virtual object in environment 302 in the unbounded mode of object capture provides visual feedback to a user of electronic device 300 regarding their positioning relative to one or more physical objects the user desires to generate virtual representations of, which improves user device interaction and reduces errors in the generation of the virtual representations.

For ease of illustration, the physical objects presented in environment 302 in the figures (e.g., cube 306) include flat surfaces. It should be appreciated that electronic device 300 may present virtual reticle 318b on surfaces of objects visible in environment 302 (e.g., rocks, trees, or furniture) that are not substantially flat (e.g., including features such as ridges, curves, and/or bumps that are optionally non-symmetrical). In some examples, electronic device 300 presents virtual reticle 318b in environment 302 along a plane that is orthogonal to a vector normal to the respective surface targeted by virtual reticle 318b (e.g., the vector is normal to a portion of the respective surface that is aligned with a center of virtual reticle 318b).

As shown in FIG. 3D, user interface 304b includes affordances 324 and 326 that are selectable to cease the capture process for the unbounded mode of object capture. In some examples, affordance 324 is selectable to cancel the capture process. For example, in response to selection of affordance 324, electronic device 300 ceases presentation of virtual reticle 318b and presents virtual reticle 318a (e.g., or optionally presents an animation of virtual reticle 318b transforming into virtual reticle 318a). Optionally, in response to selection of affordance 324, electronic device 300 ceases presentation and/or generation of a virtual representation of one or more physical objects of environment 302. In some examples, affordance 326 is selectable to present a preview user interface for a virtual representation, such as user interface 304c shown and described with reference to FIGS. 3N-3O.

In some examples, during the capture process, in response to capturing one or more sets of images of one or more physical objects (e.g., cube 306) in environment 302, electronic device 300 presents a preview of a virtual representation of the one or more physical objects (e.g., preview 328 shown and described with reference to FIGS. 3I-3M). In some examples, the virtual representation included in the preview is a point cloud representation of the one or more captured physical objects. As electronic device 300 captures images during the capture process (e.g., including images of additional surfaces and/or physical objects in environment 302), electronic device 300 updates the preview of the virtual representation (e.g., by changing and/or adding points to the point cloud representation and/or adding representations of new objects and/or surfaces).

In some examples, the preview of the virtual representation is presented on a virtual object in user interface 304b and/or within a virtual region corresponding to the virtual object. For example, in FIG. 3D, user interface 304b includes virtual object 332. In some examples, virtual object 332 corresponds to a cross-section of a three-dimensional shape, such as an ellipsoid (e.g., hemi-ellipsoid), sphere, cube, cuboid, cylinder, disk, or prism, and/or the virtual region corresponds to a volume above the virtual object 332. For ease of illustration in FIGS. 3D and 3I-3M, virtual object 332 is presented as a disc. However, it should be appreciated that virtual object 322 may be any two-dimensional and/or three-dimensional shape in which the preview of the virtual representation is presented on and/or within in user interface 304b.

In some examples, virtual object 332 and virtual region includes multiple layers. For example, the preview of the virtual representation is presented at least partially on a first layer (e.g., base layer) and within a second layer (e.g., outer layer of the virtual region). For example, the preview of the virtual representation is presented on a base layer (e.g., such as the illustration of virtual object 332 in FIG. 3D) and at least partially within a hemi-ellipsoid and/or hemi-sphere (such as the illustration of virtual object 332 in FIGS. 3E-3H).

As additional images are captured during the capture process, the preview of the virtual representation can be updated (e.g., to include new captured portions or refinements to previously captured portions). In some examples, electronic device 300 updates a preview of the virtual representation presented in user interface 304b while presenting (e.g., concurrently) an animation. FIGS. 3E-3H illustrate an example of an animation that electronic device 300 presents while updating the preview of the virtual representation, according to examples of the disclosure. As shown in FIGS. 3E-3H, virtual object 332 is a three-dimensional hemi-ellipsoid (although it should be appreciated that virtual object 332 may be any of the above-mentioned three-dimensional shapes). In FIGS. 3E-3H, a pulse 334 progresses (e.g., propagates) through respective portions of virtual object 332. For example, pulse 334 propagates from the center of virtual object 332 outward. Alternatively, in some examples, an animation (e.g., having one or more characteristics of pulse 334) propagates from the perimeter of virtual object 332 inward (e.g., toward the center of virtual object 332). In some examples, pulse 334 corresponds to a wave that ripples through the respective portions of virtual object 332. In some examples, pulse 334 corresponds to a three-dimensional shape (e.g., a hemi-ellipsoid and/or hemi-sphere) that is optionally concentric to virtual object 332 and progressively expands from the center to the perimeter of virtual object 332. In some examples, pulse 334 progresses gradually through the volume of virtual object 332 (e.g., over 0.1, 0.2, 0.5, 1, 2, 5, or 10 seconds). Additionally, or alternatively, in some examples, the animation includes changing one or more visual characteristics of virtual object 332 (e.g., and/or the preview of the virtual representation presented on and/or within virtual object 332), including opacity, color, saturation, clarity, and/or brightness. Additionally, or alternatively, in some examples, the animation includes an audio and/or haptic output (e.g., a sound of a camera shutter). For example, the propagation of pulse 334 through the volume of virtual object 332 is timed with (e.g., is presented during the same duration of) with an audio and/or haptic output.

In some examples, electronic device 300 presents the animation (e.g., pulse 334 illustrated in FIGS. 3E-3H) in response to one or more images and/or set of images being captured of the one or more physical objects of environment 302. For example, the cadence (e.g., frequency) of presenting the animation corresponds to when electronic device 300 captures the one or more images and/or set of images during the capture process (e.g., while the animation is presented, a point cloud preview of the virtual representation is updated to correspond to the one or more images and/or set of images). In some examples, electronic device 300 presents the animation (e.g., and updates the preview of the virtual representation of the one or more physical objects) at a pre-set and/or standard cadence (e.g., every 0.5, 1, 2, 5, 10, 15, 20, 25, 30, and/or 60 seconds). For example, the pre-set and/or standard cadence corresponds to a default rate (e.g., stored in a memory of electronic device 300) that electronic device 300 updates the preview of the virtual representation during the capture process.

In some examples, electronic device 300 progressively updates the preview of the virtual representation of the one or more physical objects (e.g., preview 328 shown and described with reference to FIGS. 3I-3M) as pulse 334 progresses through the volume of virtual object 332. For example, electronic device 300 presents pulse 334 with one or more dimensions corresponding to the preview of the virtual representation (e.g., such that pulse 334 progresses through the entire volume of the preview of the virtual representation during the animation (e.g., while updating the preview of the virtual representation)). For example, electronic device 300 updates a respective portion of the preview of the virtual representation (presented on and/or within virtual object 332) in accordance with a determination that a current position of pulse 334 within virtual object 332 corresponds to the respective portion of the preview (e.g., a group of points included within a point cloud preview of the one or more physical objects are updated (e.g., by adding, re-locating, removing and/or replacing points) when pulse 334 passes the location of the group of points). In some examples, updating the respective portion of the preview of the virtual representation includes reducing the opacity of (e.g., fading out) a first group of points (e.g., of a point cloud) included in the respective portion of the preview of the virtual representation. In some examples, while (or after) reducing the opacity of the first group of points (e.g., and while pulse 334 propagates through the respective portion of the preview of the virtual representation), electronic device 300 increases the opacity of (e.g., fades in) a second group of points to replace the first group of points. Updating the preview of the virtual representation of the one or more physical objects (e.g., preview 328 shown and described with reference to FIGS. 3I-3M) while the animation (e.g., pulse 334) progresses through the volume of virtual object 332 conceals the updating of the one or more points (e.g., of a point cloud representation) included in the preview, which limits distraction (e.g., caused by displaying excess movements of points in the point cloud representation) and improves user device interaction during the capture process.

FIGS. 3I-3M illustrate electronic device 300 updating a preview 328 as more regions of the three-dimensional environment are captured (e.g., as a virtual representation of one or more physical objects of environment 302 is updated). It should be appreciated that preview 328 may be presented on and/or within the example of virtual object 332 shown and described with reference to FIGS. 3E-3H. For ease of illustration, the animation (pulse 334) shown and described with reference to FIGS. 3E-3H is not shown when electronic device 300 updates preview 328 in FIGS. 3I-3M. It should be appreciated that electronic device 300 presents the animation (and version of virtual object 332) shown and described with reference to FIGS. 3E-3H when preview 328 is updated in FIGS. 3I-3M.

As shown in FIG. 3I, preview 328 is a point cloud representation of cube 306 (e.g., including a plurality of points presented to represent physical characteristics of cube 306). In some examples, electronic device 300 presents preview 328 in response to one or more images (e.g., a set of images) being captured of cube 306 (e.g., electronic device 300 creates (and presents) a point cloud representation corresponding to a targeted surface and/or physical object in the one or more captured images). Additionally, or alternatively, in some examples, electronic device 300 presents and/or updates preview 328 in accordance with a determination that virtual reticle 318b has targeted a respective region of environment 302 for more than a threshold period of time (e.g., 0.1, 0.2, 0.5, 1, 2, 5, or 10 seconds). For example, the respective region of environment 302 includes a physical object and/or surface (e.g., a surface of the physical object, such as surface 322a of cube). For example, targeting the respective region of environment 302 for more than a threshold period of time includes moving by less than a threshold amount (e.g., maintaining a view of environment 302) for more than the threshold period of time. Updating preview 328 in accordance with a determination that virtual reticle 318b targets a respective region of environment 302 for more than a threshold period of time enables the user of electronic device 300 to control what portions of environment 302 are and/or are not included in the virtual representation without having to manually define and/or adjust (e.g., through user input) the region of environment 302 included in the virtual representation, and conserves computing resources associated with user inputs to remove unwanted regions of environment 302 from the generated virtual representation (e.g., after completion of the capture process). In some examples, in response to capturing one or more additional images of cube 306 (e.g., and/or in response to virtual reticle 318b continuing to target surface 322a and/or cube 306), electronic device 300 updates preview 328 (e.g., by adding and/or removing one or more points to the point cloud representation included in preview 328 (e.g., by changing the density of the point cloud)).

FIG. 3J illustrates electronic device 300 presenting a different view of environment 302 in user interface 304b. For example, a user of electronic device 300 moves relative to environment 302 (such that a field of view of one or more image sensors of electronic device 300 (e.g., image sensor(s) 210 described above) changes). In response to the change in view of environment 302, electronic device 300 presents virtual reticle 318b at an orientation corresponding to one or more features of surface 322b of cube 306 (e.g., corresponding to the orientation of surface 322b (e.g., such that the presented orientation of virtual reticle 318b is parallel to the orientation of surface 322b)). In some examples, electronic device 300 presents virtual reticle 318b at the same display location in user interface 304b (e.g., compared to the location of virtual reticle 318b in FIG. 3I) but at a changed orientation and/or distance (e.g., corresponding to the difference in orientation and/or distance (e.g., from electronic device 300) between surface 322a in FIG. 31 and surface 322b in FIG. 3J).

During a change of view of electronic device 300 relative to environment 302 (e.g., caused by movement of electronic device 300 (e.g., based on user movement) in the physical environment), electronic device 300 optionally maintains presentation of virtual reticle 318b in user interface 304b. For example, electronic device 300 presents an animation of virtual reticle 318b changing orientation (and optionally location (e.g., depth from electronic device 300)) to correspond to one or features of the respective surface (e.g., surface 322b in FIG. 3J) that virtual reticle 318b targets at the changed viewpoint. In some examples, electronic device 300 applies a filter to the presentation of virtual reticle 318b while presenting the animation (e.g., to reduce noise and/or outlying detected changes in the viewpoint of electronic device 300 (e.g., caused by user movement)). For example, electronic device 300 applies a filter (e.g., low pass or band pass) to the presentation of virtual reticle 318b when changing the orientation and/or depth (e.g., location) of virtual reticle 318b during the change in viewpoint of electronic device 300. Filtering movement (e.g., changes in the orientation) of virtual reticle 318b improves user device interaction by preventing sudden and/or unexpected movements of virtual reticle 318b during the capture process that could distract the user of electronic device 300, and conserves computing resources by limiting the amount of change in the presentation of virtual reticle 318b to only changes that are useful to the user (e.g., to guide the user in their positioning of electronic device 300 relative to cube 306) during the capture process.

In some examples, in response to the change of view of electronic device 300 relative to environment 302, electronic device 300 updates preview 328. For example, electronic device 300 presents the virtual representation (e.g., point cloud representation) in preview 328 at an arrangement that corresponds to the current view of environment 302. In FIG. 3J, the arrangement of the virtual representation of cube 306 included in preview 328 corresponds the arrangement of cube 306 in the current view of environment 302 (e.g., the arrangement of the virtual representation of cube 306 in preview 328 corresponds to the viewing angle of electronic device 300 (and the user of electronic device 300) to cube 306 in the current view of environment 302). In some examples, electronic device 300 updates the arrangement of preview 328 concurrently with a change in view of environment 302 (e.g., such that a current arrangement of preview 328 corresponds to a current arrangement of a physical object (e.g., cube 306) visible in the current view of environment 302). For example, in FIG. 3J, electronic device 300 rotates preview 328 clockwise while the viewpoint of electronic device 300 changes between FIG. 3I (when virtual reticle 318b targets surface 322a) and FIG. 3J (when virtual reticle 318b targets surface 322b). For example, if the view of environment 302 changes in an opposite direction compared to the direction shown in FIGS. 3I-3J (e.g., electronic device 300 is moved leftward instead of rightward), electronic device 300 rotates preview 328 counter-clockwise while the viewpoint of electronic device 300 relative to environment 302 changes. For example, in FIG. 3J, electronic device 300 changes a vertical tilt of preview 328 (e.g., to change a vertical viewing angle to the virtual representation of cube 306) while the viewpoint of electronic device 300 relative to environment 302 changes between FIG. 3I (when electronic device 300 has a less downward viewing angle to cube 306 in environment 302) and FIG. 3J (when electronic device 300 has a more downward viewing angle to cube 306 in environment 302). In some examples, updating the arrangement of preview 328 includes updating an arrangement of virtual object 332 (e.g., electronic device 300 rotates and/or tilts virtual object 332 concurrently with preview 328 to correspond to the presented view of environment 302).

In some examples, updating preview 328 (e.g., in response to a change of view of electronic device 300, as described with reference to FIG. 3J) includes adding one or more points to and/or removing one or more points from the point cloud representation included in preview 328. In some examples, electronic device 300 adds a representation of a respective region of environment 302 (e.g., by adding one or more points to the point cloud representation) in response to virtual reticle 318b targeting the region of environment 302 for more than a threshold period of time (e.g., as described above). For example, adding the representation of the respective region of environment 302 to preview 328 includes fading in the representation of the respective region of environment 302 (e.g., by gradually increasing the opacity of one or more points of a point cloud representation of the respective region of environment (e.g., while presenting the animation shown and described with reference to FIGS. 3E-3H, or over a period of time such as 0.1, 0.2, 0.5, 1, 2, 5, or 10 seconds)). In some examples, electronic device 300 removes a representation of a respective region of environment 302 (e.g., by removing one or more points from the point cloud representation) in accordance with a determination that virtual reticle 318b has targeted the respective region of environment 302 for less than a threshold amount of time over the duration of the capture process (e.g., the threshold amount of time corresponds to a proportion of the duration of the capture process (e.g., 0.5, 1, 2, 5, 10, 15, 20, 25, or 50 percent of the duration of the capture process), or a period of time (e.g., 0.1, 0.2, 0.5, 1, 2, 5, 10, 25, or 30 seconds)). For example, removing the representation of the respective region of environment 302 from preview 328 includes fading out the representation of the respective region of environment 302 (e.g., by gradually decreasing the opacity of one or more points of a point cloud representation of the respective region of environment 302 (e.g., while presenting the animation shown and described with reference to FIGS. 3E-3H, or over a period of time such as 0.1, 0.2, 0.5, 1, 2, 5, or 10 seconds)). In some examples, updating the preview 328 includes adding a first region of environment 302 to preview 328 (e.g., in accordance with a determination that virtual reticle 318b has targeted the first region for more than a threshold amount of time) and removing a second region of environment 302 from preview 328 (e.g., in accordance with a determination that virtual reticle 318b has targeted the second region of environment 302 for less than a threshold period of time over the duration of the capture process). Updating preview 328 to remove one or more portions of preview 328 in response to virtual reticle 318b targeting a respective region of environment 302 (e.g., that corresponds to the one or more portions of preview 328) for less than a threshold amount of time during the capture process improves responsiveness and usefulness of the presentation of preview 328 (e.g., by including the portions of environment 302 that the user of electronic device 300 intends to include in the virtual representation), and conserves computing resources associated with user inputs to remove unwanted portions of the generated virtual representation (e.g., after completion of the capture process).

In some examples, in the unbounded mode of object capture, the capture process is not bounded to a pre-defined region of the environment 302 (e.g., unlike the bounded mode of object capture). FIG. 3K illustrates electronic device 300 capturing one or more images and/or a set of images of another object in the environment, such as pyramid 336. In some examples, pyramid 336 is a physical object (e.g., from the physical environment) that is visible in the current view of environment 302 (shown in user interface 304b). For example, pyramid 336 is located in a different region of environment 302 than cube 306 (shown in FIGS. 3I-3J) (e.g., a user of electronic device 300 moves in the physical environment away from a location of cube 306 and to a location of pyramid 336).

In some examples, electronic device 300 expands the virtual representation of the one or more physical objects being generated during the capture process to include additional surfaces and/or physical objects of environment 302. In FIG. 3K, preview 328 includes a virtual representation (e.g., a point cloud representation) that includes a greater portion of environment 302 than previously presented in FIGS. 3I-3J (to include pyramid 336 in addition to cube 306). In some examples, electronic device 300 expands the virtual representation to include additional surfaces and/or physical objects in accordance with a determination that virtual reticle 318b has targeted a respective surface and/or physical object (e.g., surface 338 of pyramid 336) for more than a threshold period of time (e.g., 0.1, 0.2, 0.5, 1, 2, 5, or 10 seconds). For example, in FIG. 3K, electronic device 300 determines that virtual reticle 318b has targeted pyramid 336 for more than the threshold period of time and updates the virtual representation being generated to include a point cloud representation of pyramid 336 (as shown in preview 328).

Although not shown in FIG. 3K (or in FIGS. 3L-3M), in some examples, electronic device 300 includes one or more representations of environment 302 in preview 328 that are different from cube 306 and/or pyramid 336. For example, electronic device 300 includes features that represent the physical environment that cube 306 and/or pyramid 336 are located in (e.g., features of an indoor physical environment (e.g., a floor, walls, furniture, etc.) or features of an outdoor physical environment (e.g., a sky, ground, trees, plants, rocks, etc.)). For example, the one or more representations of environment 302 correspond to features of environment 302 included in one or more images captured as electronic device 300 moves (e.g., based on user movement) from the location of cube 306 to the location of pyramid 336 (e.g., the features of environment 302 correspond to physical features of the physical environment that are located between cube 306 and pyramid 336). In some examples, electronic device 300 presents the one or more representations of environment 302 different from cube 306 and/or pyramid 336 (and/or hexagonal prism 344 shown in FIG. 3M) in user interface 304c (shown in FIGS. 3N-3O) in response to selection of icon 358 (shown and described with reference to FIG. 3N).

In some examples, when expanding the virtual representation to include representations of one or more additional surfaces and/or physical objects, electronic device 300 scales a size of preview 328 presented in user interface 304b. For example, in FIG. 3K, electronic device 300 scales preview 328 in response to the addition of pyramid 336 to the virtual representation. In some examples, electronic device 300 scales the size of preview 328 to fit on and/or within the volume of virtual object 332 and/or virtual region around the virtual object (e.g., electronic device 300 maintains the size of virtual object 332 and/or virtual region around the virtual object when scaling preview 328). For example, in FIG. 3K, electronic device decreases the size of preview 328 relative to virtual object 332 (e.g., the point cloud representation of cube 306 in FIG. 3K is smaller compared to FIGS. 3I-3J (e.g., to fit the point cloud representation of pyramid 336 on and/or within virtual object 332 with the point cloud representation of cube 306)). In some examples, as shown in FIG. 3K, scaling the size of preview 328 includes centering the changed size of preview 328 relative to virtual object 332. In some examples, scaling the preview includes decimating one or more points of a previously presented point cloud representation (e.g., the point cloud representation of cube 306 previously presented in FIGS. 3I-3J). For example, electronic device 300 removes one or more points of the point cloud representation included in preview 328 when decreasing the size of preview 328 (e.g., to avoid causing one or more points of the point cloud representation of cube 306 to overlap at the decreased size). In some examples, electronic device 300 scales preview 328 and/or decimates the one or more points of the point cloud representation while an animation is presented (e.g., having one or more characteristics of the animation shown and described with reference to FIGS. 3E-3H). Additionally, or alternatively, in some examples, electronic device 300 applies a noise field to preview 328 (e.g., a fixed noise field) and/or virtual object 332 when scaling preview to fit within and/or on virtual object 332 (e.g., to prevent excess movement of one or more points of the point cloud preview during the scaling of preview 328). Scaling a size of preview 328 to fit on and/or within virtual object 332 provides visual feedback to a user of electronic device 300 during the unbounded mode of object capture of the size and/or scope of the virtual representation being generated by electronic device 300 (e.g., including visual feedback on what physical objects are being included in the generated virtual representation), and allows a user to view the entire preview of the virtual representation despite its increased size, which reduces errors in interaction during the object capture process (e.g., associated with the user being uninformed of the size and/or scope of the virtual representation being generated).

In FIG. 3K, electronic device 300 presents virtual reticle 318b at a depth (e.g., from electronic device 300 in environment 302) corresponding to surface 338 of pyramid 336. In some examples, surface 338 is farther from electronic device 300 than surfaces 322a and/or 332b of cube 306. Accordingly, in FIG. 3K, electronic device 300 presents virtual reticle 318b at a farther depth from electronic device 300 in environment 302 than in FIGS. 3I-3J. For example, in FIG. 3K, electronic device 300 presents virtual reticle 318b on (and/or snapped to) surface 338. As shown in FIG. 3K, electronic device 300 presents virtual reticle 318b at an orientation corresponding to one or more features of surface 338 (e.g., having one or more characteristics of presenting virtual reticle 318b at an orientation corresponding to the one or more features of surfaces 322a and/or 322b described above).

In some examples, electronic device 300 maintains presentation of virtual reticle 318b with the same size relative to environment 302 during the capture process. For example, in FIGS. 3I-3J, electronic device 300 presents virtual reticle 318b with a first size relative to environment 302 (e.g., while virtual reticle 318b is presented on (e.g., snapped to) surface 322a and/or 322b of cube 306). For example, in response to the change in view of electronic device 300 relative to environment 302 in FIG. 3K, electronic device 300 maintains presentation of virtual reticle 318b with the first size relative to environment 302 (e.g., while virtual reticle 318b is presented on (e.g., snapped to) surface 338 of pyramid 336). In some examples, because pyramid 336 is a greater distance from electronic device 300 than cube 306, electronic device 300 presents virtual reticle 318b with a different display size in FIG. 3K compared to FIGS. 3I-3J (since electronic device 300 maintains the same size of virtual reticle 318b when presenting virtual reticle 318b at different depths from electronic device 300 in environment 302). Maintaining a size of virtual reticle 318b relative to environment 302 (and/or changing a display size of virtual reticle 318b) when changing a distance virtual reticle 318b is presented at in environment 302 (e.g., to correspond to a targeted surface) provides visual feedback to a user of the distance of a targeted surface and/or object from electronic device 300 during the capture process (e.g., and guides the user in moving to an appropriate distance from the targeted surface and/or object for capturing images), thereby reducing errors in interaction (e.g., associated with capturing images that are not sufficient for generating an accurate virtual representation of the targeted surface and/or object).

Alternatively, or additionally, in some examples, electronic device 300 presents virtual reticle 318b at an offset distance (e.g., a fixed offset distance) from a targeted surface and/or object (e.g., surface 338 of pyramid 336) in environment 302. For example, electronic device 300 presents virtual reticle 318b at a fixed distance (e.g., 0.01, 0.02, 0.05, 0.1, 0.2, 0.5, or 1 m) from a targeted surface in environment 302 (e.g., the fixed distance is measured from the targeted surface toward a location corresponding to electronic device 300 in environment 302). In some examples, electronic device 300 presents virtual reticle 318b at different respective fixed distances based on the distance of the targeted surface and/or object from electronic device 300. For example, in accordance with a determination that a targeted surface (e.g., surface 338) is within a first range of distances from electronic device 300 in environment 302, electronic device 300 presents virtual reticle 318b at a first fixed distance from the targeted surface in environment 302, and in accordance with a determination that the targeted surface is within a second range of distances, different from the first range of distances, from electronic device 300 in environment 302, electronic device 300 presents virtual reticle 318b at a second fixed distance, different from the first fixed distance, from the targeted surface in environment 302 (e.g., the first range of distances is greater than the second range of distances, and the first fixed distance is greater than the second fixed distance).

Alternatively, or additionally, in some examples, electronic device 300 presents virtual reticle 318b at a distance from a targeted surface (e.g., surface 338 of pyramid 336) in environment 302 (and/or from a location corresponding to electronic device 300) that is a function of a distance between the targeted surface and electronic device 300. For example, the function is a linear function (e.g., the greater the distance of the targeted surface is from electronic device 300, the greater the distance electronic device 300 presents virtual reticle 318b from the targeted surface in environment 302). For example, the function is a non-linear function (e.g., a parabolic function or exponential function). In some examples, electronic device 300 presents virtual reticle 318b at a distance from a targeted surface (and/or from a location corresponding to electronic device 300) using different functions corresponding to different ranges of distances from a targeted surface (e.g., surface 338 of pyramid 336). For example, in accordance with a determination that the targeted surface is within a first range of distances from electronic device 300, electronic device 300 presents virtual reticle 318b at a distance (e.g., depth from electronic device 300 and/or distance relative to the targeted surface) in environment 302 using a first function, and in accordance with a determination that the targeted surface is within a second range of distances, different from the first range of distances, from electronic device 300, electronic device 300 presents virtual reticle 318b at a distance (e.g., depth from electronic device 300 and/or distance relative to the targeted surface) in environment 302 using a second function, different from the first function (e.g., the first function includes a different linear relationship between the distance of the targeted surface from electronic device 300 and the distance of presentation of virtual reticle 318b (e.g., relative to the targeted surface and/or electronic device 300) than the second function, or the first function is a linear function and the second function is a non-linear function). Optionally, in accordance with a determination that the targeted surface is within a third range of distances from electronic device, different from the first range of distances and the second range of distances, electronic device 300 presents virtual reticle 318b at a distance (e.g., from electronic device 300 and/or relative to the targeted surface) using a third function, different from the first function and the second function (e.g., the third function is a non-linear function, and the first function and/or second function are linear functions).

Alternatively, or additionally, in some examples, electronic device 300 presents virtual reticle 318b at a same (e.g., fixed) location in environment 302 (e.g., does not change the depth of virtual reticle 318b in environment 302 to correspond to a respective surface targeted by virtual reticle 318b) and changes the size of virtual reticle 318b relative to environment 302 (and the display size of virtual reticle 318b) based on the distance of a respective surface targeted by virtual reticle 318b. For example, electronic device 300 presents virtual reticle 318b at the same location (e.g., distance from electronic device 300) in environment 302 in FIGS. 3I-3J as in FIG. 3K and with a smaller size relative to environment 302 in FIG. 3K (e.g., because pyramid 336 is a farther distance from electronic device 300 than cube 306).

Alternatively, or additionally, in some examples, electronic device 300 presents virtual reticle 318b with one of a plurality of pre-set sizes (e.g., stored in a memory of electronic device 300) relative to environment 302 (e.g., each of the plurality of pre-set sizes correspond to a range of distances from electronic device 300). For example, in accordance with a determination that a respective surface targeted by virtual reticle 318b is within a first range of distances (e.g., 0.1-1 m) from electronic device 300, electronic device 300 presents virtual reticle 318b with a first size relative to environment 302. For example, in accordance with a determination that a respective surface targeted by virtual reticle 318b is within a second range of distances (e.g., 1-5 m), different from the first range of distances, electronic device 300 presents virtual reticle 318b with a second size, different from the first size, relative to environment 302. For example, in accordance with a determination that a respective surface targeted by virtual reticle 318b is within a third range of distances (e.g., greater than 5 m), different from the first and second range of distances, electronic device 300 presents virtual reticle 318b with a third size, different from the first size and second size, relative to environment 302.

In some examples, electronic device 300 applies a filter to the movement of virtual reticle 318b in environment 302 (e.g., in depth relative to electronic device 300 (e.g., when snapping from a first targeted surface to a second targeted surface)). In some examples, electronic device 300 applies a different filter to the movement of virtual reticle 318b depending on the amount of change in location of virtual reticle 318b. For example, in accordance with a determination that the difference in distance between a first targeted surface (e.g., surface 322b shown in FIG. 3J) and a second targeted surface (e.g., surface 338 shown in FIG. 3K) is less than a threshold amount of distance (e.g., less than 0.1, 0.2, 0.5, 1, 2, 5, or 10 meters) from electronic device 300, electronic device 300 applies a first type of filter (e.g., a low pass filter) to the movement of virtual reticle 318b from the first targeted surface to the second targeted surface. For example, in accordance with a determination that the difference in distance between the first targeted surface and the second targeted surface is greater than the threshold amount of distance (e.g., greater than 0.5, 1, 2, 5, 10, 25, or 50 meters) from electronic device 300, electronic device 300 applies a second type of filter (e.g., a band pass filter), different from the first type of filter. Filtering movement (e.g., changes in depth) of virtual reticle 318b improves user device interaction by preventing unnecessary and/or excess movements of virtual reticle 318b during the capture process that could distract the user of electronic device 300, and conserves computing resources by limiting the presented movements of virtual reticle 318b to only those that are useful to the user (e.g., to guide the user in their positioning of electronic device 300 relative to the one or more physical objects of environment 302) during the capture process. Applying different filters to the movement (e.g., change in depth) of virtual reticle 318b based on the amount of movement of virtual reticle 318b (e.g., corresponding to the amount of distance between a targeted surface and electronic device 300) conserves computing resources by applying more selective (and/or resource intensive) filters only when it is necessary for efficiently controlling the presented movements of virtual reticle 318b.

In some examples, during the capture process, electronic device 300 presents virtual reticle 318b when a targeted surface is within a range of distances (e.g., within 1, 2, 5, 10, 20, 25, 50, or 100 meters, and/or greater than 0.01, 0.05, 0.1, 0.2, 0.5, or 1 meter). FIG. 3L illustrates electronic device 300 ceasing to present virtual reticle 318b in user interface 304b in accordance with a determination that a targeted surface is outside of the range of distances. As shown in FIG. 3L, electronic device 300 presents a view of environment 302 that includes cone 340. In some examples, cone 340 is a physical object (e.g., from the physical environment) that is visible in the current view of environment 302 shown in user interface 304b. For example, cone 340 is located in a different region of environment 302 than cube 306 (shown in FIGS. 3I-3J) and pyramid 336 (shown in FIG. 3K) (e.g., a user of electronic device 300 moves in the physical environment away from a location of pyramid 336 and to a location of cone 340).

In some examples, the range of distances for presenting virtual reticle 318b corresponds to a range of distances at which electronic device 300 may effectively generate a virtual representation of a targeted object. For example, in FIG. 3L, cone 340 is at a distance from electronic device 300 that is too far for effectively generating a virtual representation (e.g., a point cloud representation) of cone 340 (e.g., electronic device 300 is not able to capture one or more images of cone 340 that can be effectively used to generate a virtual representation of cone 340 because of the distance between cone 340 and electronic device 300). Optionally, in accordance with a determination that a targeted object (e.g., cone 340) is not within the range of distances from electronic device 300, electronic device 300 forgoes capturing one or more images of the targeted object (and/or ceases capturing images of environment 302) (e.g., because the one or more images cannot be used to generate the virtual representation). Ceasing to present virtual reticle 318b when a targeted surface and/or object is outside of a range of distances from electronic device 300 provides visual feedback to a user of electronic device 300 of their positioning relative to the targeted surface and/or object (e.g., cone 340), which improves user device interaction (e.g., by guiding the user to move electronic device 300 in environment 302 to a location where electronic device 300 can more effectively capture images of the targeted surface and/or object) and reduces errors in the generation of the virtual representation (e.g., caused by the positioning of electronic device 300 relative to the one or more physical objects of environment 302).

In FIG. 3L, user interface 304b includes a visual indication 342 associated with the capture process. In some examples, visual indication 342 is presented to guide the user of electronic device 300 to move electronic device 300 closer to cone 340 such that cone 340 is within the range of distances (e.g., for capturing one or more images of cone 340 that can be used to generate a virtual representation of cone 340). Electronic device 300 optionally maintains presentation of visual indication 342 (e.g., and/or does not present virtual reticle 318b) until cone 340 is within the range of distances (e.g., caused by movement of electronic device 300 toward the location of cone 340). For example, in accordance with a determination that a targeted surface (e.g., a surface of cone 340) is within the range of distances, electronic device 300 ceases to present visual indication 342 and presents virtual reticle 318b at a location and/or orientation corresponding to one or more features of the targeted surface (e.g., as described above). Additionally, or alternatively to presenting visual indication 342, electronic device 300 provides audio and/or haptic output (e.g., to alert the user of electronic device 300 to move closer to cone 340). Presenting visual indication 342 provides visual feedback to a user of electronic device 300 of their positioning relative to the targeted surface and/or object (e.g., cone 340), which improves user device interaction (e.g., by guiding the user to move electronic device 300 closer to targeted surface and/or object such that electronic device 300 can more effectively capture images of the targeted surface and/or object) and reduces errors in the generation of the virtual representation (e.g., caused by electronic device 300 being too far from the targeted surface and/or object).

In some examples, electronic device 300 presents one or more visual indications different from visual indication 342 during the capture process. For example, in accordance with a determination that a targeted surface is too close to electronic device 300 (e.g., such that one or more images cannot be effectively captured of the targeted surface), electronic device 300 presents a visual indication (and/or an audio and/or haptic output) to instruct a user of electronic device 300 to move farther from the targeted surface. For example, in accordance with a determination that movement of electronic device 300 in environment 302 is too quick (e.g., such that one or more images cannot be effectively captured of the one or more physical objects in environment 302), electronic device 300 presents a visual indication (and/or an audio and/or haptic output) to instruct a user of electronic device 300 to move slower. For example, in accordance with a determination that electronic device 300 has moved less than a threshold amount (e.g., less than 0.01, 0.05, 0.1, 0.2, 0.5, or 1 meter) over a threshold period of time (e.g., 1, 2, 5, 10, 15, 30, or 60 seconds), electronic device 300 presents a visual indication (and/or an audio and/or haptic output) to instruct a user of electronic device 300 to initiate movement relative to environment 302.

As shown FIG. 3L, electronic device 300 does not update preview 328 to include a representation of cone 340. In some examples, electronic device 300 does not create a virtual representation of cone 340 to add to the virtual representation (of cube 306 and pyramid 336) because cone 340 is outside of the range of distances (e.g., electronic device 300 does not capture one or more images of cone 340 that can be used to generate the virtual representation). In some examples, in accordance with a determination that electronic device 300 is moved to within the range of distances from cone 340 (e.g., such that electronic device 300 captures one or more images that can be used to generate a virtual representation of cone 340), electronic device 300 adds a representation of cone 340 to the virtual representation and updates preview 328 (e.g., by adding a point cloud representation of cone 340 and optionally scaling preview 328 as described above with reference to FIG. 3K).

FIG. 3M illustrates electronic device 300 presenting a view of environment 302 that includes a hexagonal prism 344. In some examples, hexagonal prism 344 is a physical object (e.g., from the physical environment) that is visible in the view of environment 302 shown in user interface 304b. For example, hexagonal prism 344 is located in a different region of environment 302 than cube 306 (shown in FIGS. 3I-3J), pyramid 336 (shown in FIG. 3K), and cone 340 (shown in FIG. 3L) (e.g., a user of electronic device 300 moves in the physical environment away from a location of cone 340 and to a location of hexagonal prism 344).

In some examples, in FIG. 3M, hexagonal prism 344 is within the range of distances from electronic device 300 for presenting virtual reticle 318b (and for generating a virtual representation of hexagonal prism 344). In some examples, in response to detecting a surface and/or physical object that is within the range of distances from electronic device 300, electronic device 300 ceases to present visual indication 342 (shown in FIG. 3L) and presents virtual reticle 318b. In some examples, electronic device 300 presents virtual reticle 318b at an orientation and/or location (e.g., depth from electronic device 300) corresponding to one or more features of surface 346 of hexagonal prism 344 (e.g., having one or more characteristics of presenting virtual reticle 318b at an orientation and/or location corresponding to one or more features of surfaces 322a, 322b and/or 338 described above). As shown in FIG. 3M, electronic device 300 updates preview 328 to include hexagonal prism 344 (e.g., updating preview 328 to include hexagonal prism 344 has one or more characteristics of updating preview to include pyramid 336 described with reference to FIG. 3K). For example, electronic device 300 scales preview 328 such that the point cloud representation of cube 306, pyramid 336, and hexagonal prism 344 is presented on and/or within virtual object 332. In some examples, electronic device 300 does not include cone 340 (shown in FIG. 3L) in preview 328 in FIG. 3K because electronic device 300 was not moved (e.g., by a user of electronic device 300) such that cone 340 was within the range of distances of electronic device 300 (e.g., and electronic device 300 did not create a virtual representation of cone 340).

In FIG. 3M, electronic device 300 detects a touch input 316c corresponding to selection of affordance 326 (e.g., touch input 316c has one or more characteristics of touch input 316a described above). In response to detecting touch input 316c, electronic device 300 ceases (e.g., temporarily) the capture process in the unbounded mode of object capture and presents a user interface 304c in FIG. 3N. In some examples, user interface 304c corresponds to a preview user interface for viewing a virtual representation 348. In some examples, virtual representation 348 corresponds to the virtual representation generated by electronic device 300 during the capture process (e.g., corresponding to the point cloud representation shown in preview 328 in FIG. 3M). As shown in FIG. 3N, virtual representation 348 includes representations of cube 306, pyramid 336, and hexagonal prism 344, which were the physical objects of environment 302 captured by electronic device 300 (e.g., through sets of images) during the capture process.

As shown in FIG. 3N, user interface 304c includes multiple affordances and/or icons that are selectable (e.g., through touch inputs). In some examples, affordance 350 is selectable for exiting user interface 304c. For example, in response to selection of affordance 350, electronic device 300 terminates the capture process and the generation of virtual representation 348 (e.g., electronic device 300 deletes (e.g., does not save and/or export a file associated with) virtual representation 348). Optionally, in response to selection of affordance 350, electronic device 300 presents a visual indication that includes an affordance that is selectable to confirm that a user of electronic device 300 intends to cancel the capture process and/or the generation of virtual representation 348. In some examples, affordance 352 is selectable to resume the capture process. For example, in response to selection of affordance 352, electronic device 300 presents user interface 304b (e.g., including virtual reticle 318b) and resumes capturing images of environment 302 (e.g., in accordance with a determination that a targeted surface and/or physical object is within the range of distances from electronic device 300). In some examples, affordance 354 is selectable to conclude the capture process and/or finalize virtual representation 348. For example, in response to selection of affordance 354, electronic device 300 saves (e.g., in a memory of electronic device 300) and/or exports a file including information (e.g., data) associated with virtual representation 348. In some examples, icon 356 is selectable to present one or more indications corresponding to one or more images captured by electronic device 300 during the capture process (e.g., as shown and described with reference to FIG. 3O). In some examples, icon 358 is selectable to present virtual representation 348 with one or more additional captured features of environment 302. For example, in response to detecting selection of icon 358, electronic device 300 presents virtual representation 348 with representations of the portions of environment 302 captured in the sets of images different from cube 306, pyramid 336, and hexagonal prism 344, such as a representation of a floor (e.g., of an indoor physical environment), ground (e.g., of an outdoor physical environment), or background features (e.g., walls and/or ceilings of an indoor physical environment, or a landscape and/or the sky of an outdoor physical environment). In some examples, after presenting the representations of the portions of environment 302 captured in the sets of images different from cube 306, pyramid 336, and hexagonal prism 344, in response to detecting selection of icon 358, electronic device 300 ceases to present the portions of environment 302 different from cube 306, pyramid 336, and hexagonal prism 344.

In FIG. 3M, electronic device 300 detects a touch input 316d corresponding to selection of icon 356 (e.g., touch input 316d has one or more characteristics of touch input 316a described above). In response to detecting touch input 316d, electronic device 300 presents a plurality of indications 360 in FIG. 3O corresponding to a plurality of images of environment 302 captured during the capture process. For example, indications 360 represent a quantity of images captured during the capture process (e.g., each indication of the plurality of indications 360 corresponds to a captured image). For example, indications 360 represent the locations at which images were captured during the capture process (e.g., based on the movement of electronic device 300 relative to environment 302 during the capture process). In some examples, electronic device 300 updates indications 360 in accordance with additional images being captured during the capture process (e.g., if a user of electronic device 300 selects affordance 352 to continue capturing one or more images of surfaces and/or physical objects of environment 302). In some examples, after presenting indications 360 in FIG. 3O, in response to detecting selection of icon 356, electronic device 300 ceases to present indications 360 in user interface 304b (e.g., and presents virtual representation 348 without indications 360, as shown in FIG. 3M). Presenting indications 360 in user interface 304c provides a continuous and guided user interface experience for the unbounded mode of object capture by presenting visual feedback to a user of electronic device 300 of the images that were used to generate virtual representation 348 (which helps the user make an informed decision of whether to resume the capture process to capture additional images (e.g., at different locations and/or angles) to further develop virtual representation 348), thereby improving user device interaction and reducing errors in interaction.

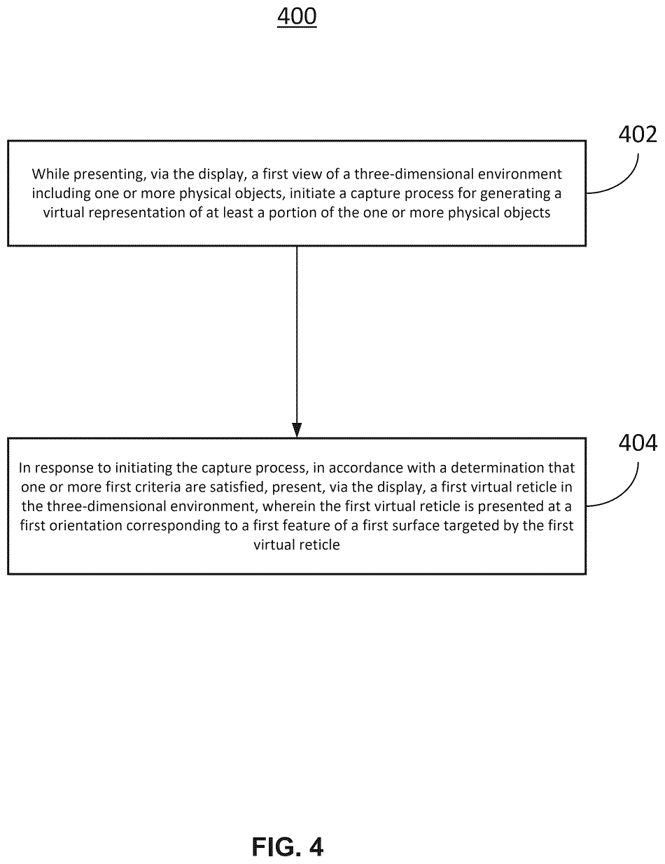

FIG. 4 illustrates a flow diagram for method 400 of initiating a capture process for generating a virtual representation of one or more physical objects, according to examples of the disclosure. In some examples, method 400 begins at an electronic device in communication with (e.g., including or communicating signals with) a display and one or more input devices (e.g., image sensor(s) 210, location sensor(s) 214, orientation sensor(s) 216, microphone(s) 218, and/or touch-sensitive surface(s) 220 shown and described with reference to FIG. 2). In some examples, the electronic device has one or more characteristics of electronic devices 100, 200, and/or 300 described above. In some examples, the electronic device is a mobile device, such as a mobile phone, tablet, and/or laptop computer. In some examples, the electronic device is a head-mounted device (e.g., including one or more displays for presenting an XR environment).

At 402, while presenting, via the display, a first view of a three-dimensional environment including one or more physical objects, the electronic device initiates a capture process for generating a virtual representation of at least a portion of the one or more physical objects. In some examples, the three-dimensional environment is an XR environment having one or more characteristics of environment 302 shown and described with reference to FIGS. 3A-3O. In some examples, the first view of the three-dimensional environment has one or more characteristics of the view of environment 302 shown in user interface 304b in FIG. 3C. In some examples, the capture process for generating a virtual representation of the at least the portion of the one or more physical objects has one or more characteristics of the capture process shown and described with reference to FIGS. 3C-3M. For example, the capture process is in an unbounded mode of object capture (e.g., having one or more characteristics of the unbounded mode of object capture described above). In some examples, the electronic device initiates the capture process in response to detecting a user input corresponding to a request to initiate the capture process. For example, the user input has one or more characteristics of the selection of affordance 320 shown and described with reference to FIG. 3C.

At 404, in response to initiating the capture process, in accordance with a determination that one or more first criteria are satisfied, the electronic device presents, via the display, a first virtual reticle in the three-dimensional environment, wherein the first virtual reticle is presented at a first orientation corresponding to a first feature of a first surface targeted by the first virtual reticle. In some examples, the first virtual reticle has one or more characteristics of virtual reticle 318b shown and described with reference to FIG. 3D and FIGS. 3I-3M. In some examples, the first orientation corresponds to an arrangement of the first surface in the first view of the three-dimensional environment. For example, as shown in FIG. 3D, electronic device 300 presents virtual reticle 318b at an orientation in environment 302 that corresponds to (e.g., is parallel to) the orientation of surface 322a of cube 306. The electronic device optionally presents the first virtual reticle at a location in the three-dimensional environment (e.g., at a distance from the electronic device) that corresponds to the location of the first surface. For example, the electronic device presents the first virtual reticle on (e.g., snapped to) the first surface, such as electronic device 300 presenting virtual reticle 318b on surface 346 of hexagonal prism 344 in FIG. 3M.

In some examples, in response to a change in view of the electronic device relative to the three-dimensional environment, electronic device presents a second view, different from the first view, of the three-dimensional environment, such as the changed view of environment 302 presented by electronic device 300 in FIG. 3J compared to FIG. 31. In some examples, in accordance with a determination that the first virtual reticle targets a second surface (optionally different from the first surface), the electronic device presents the first virtual reticle at a second orientation, different from the first orientation, corresponding to a second feature of the second surface targeted by the first virtual reticle, such as electronic device 300 changing the orientation of virtual reticle 318b in FIG. 3J from the orientation of virtual reticle 318b in FIG. 3I. For example, the second feature of the second surface corresponds to a different arrangement (e.g., orientation) in the three-dimensional environment compared to the first feature of the first surface. For example, presenting the first virtual reticle at the second orientation includes presenting the first virtual reticle parallel to the second surface (e.g., from the current viewpoint of the electronic device) (and/or along a plane that is orthogonal to a vector that is normal to the second feature of the second surface).

In some examples, when presenting the first virtual reticle at the first orientation, the electronic device presents the first virtual reticle at a first distance in the three-dimensional environment from the electronic device, such as the distance of virtual reticle 318b in environment 302 from electronic device 300 shown in FIG. 3J. For example, the first distance corresponds to a distance between the electronic device and the first surface (e.g., the first virtual reticle is presented on and/or snapped to the first surface). In some examples, in response to a change in view of the electronic device relative to the three-dimensional environment, the electronic device presents the first virtual reticle at a second distance, different form the first distance, in the three-dimensional environment, such as the distance of virtual reticle 318b in environment 302 from electronic device 300 shown in FIG. 3K. For example, the second distance corresponds to a distance between the electronic device and the second surface (e.g., the first virtual reticle is presented on and/or snapped to the second surface, or presented at an offset distance from the second surface). In some examples, the electronic device presents the first virtual reticle with the same size relative to the three-dimensional environment at the first distance and at the second distance (e.g., as described with reference to virtual reticle 318b in FIG. 3K).

Therefore, according to the above, some examples of the disclosure are directed to a method performed at an electronic device in communication with a display and one or more input devices. In some examples, the method comprises, while presenting, via the display, a first view of a three-dimensional environment including one or more physical objects, initiating a capture process for generating a virtual representation of at least a portion of the one or more physical objects. In some examples, the method further comprises, in response to initiating the capture process, in accordance with a determination that one or more first criteria are satisfied, presenting, via the display, a first virtual reticle in the three-dimensional environment, wherein the first virtual reticle is presented at a first orientation corresponding to a first feature of a first surface targeted by the first virtual reticle.

Additionally, or alternatively, in some examples, the method further comprises, while presenting, via the display, a second view, different from the first view, of the three-dimensional environment, presenting, via the display, the first virtual reticle in the three-dimensional environment at a second orientation, different from the first orientation, corresponding to a second feature of a second surface targeted by the first virtual reticle.

Additionally, or alternatively, in some examples, presenting the first virtual reticle in the three-dimensional environment at the first orientation includes presenting the first virtual reticle at a first depth in the three-dimensional environment corresponding to a depth of the first surface.

Additionally, or alternatively, in some examples, presenting the first virtual reticle on the first surface in the three-dimensional environment includes presenting the first virtual reticle with a first size relative to the three-dimensional environment. In some examples, the method further comprises while presenting, via the display, a second view, different from the first view, of the three-dimensional environment, presenting, via the display, the first virtual reticle at a second depth in the three-dimensional environment corresponding to a depth of a second surface, different from the first surface, with the first size relative to the three-dimensional environment, wherein the depth of the first surface is a different distance from the electronic device than the depth of the second surface.

Additionally, or alternatively, in some examples, the one or more first criteria include a criterion that is satisfied when a respective surface of the one or more physical objects that is targeted by the first virtual reticle is within a range of distances from the electronic device.

Additionally, or alternatively, in some examples, the method further comprises while presenting the first virtual reticle in the three-dimensional environment, wherein the three-dimensional environment is presented from a second view, different from the first view, detecting, via the one or more input devices, a second surface, different from the first surface, targeted by the first virtual reticle. In some examples, the method further comprises, in response to detecting the second surface targeted by the first virtual reticle, in accordance with a determination that the second surface targeted by the first virtual reticle is within the range of distances from the electronic device, presenting, via the display, the first virtual reticle at a second orientation, different from the first orientation, corresponding to a second feature of the second surface targeted by the first virtual reticle. In some examples, the method further comprises, in response to detecting the second surface targeted by the first virtual reticle, in accordance with a determination that the second surface targeted by the first virtual reticle is outside of the range of distances from the electronic device, ceasing presentation of the first virtual reticle in the three-dimensional environment.

Additionally, or alternatively, in some examples, the method further comprises, in accordance with the determination that the second surface targeted by the first virtual reticle is outside of the range of distances from the electronic device, presenting, via the display, a visual indication associated with the capture process.

Additionally, or alternatively, in some examples, the first surface is a first distance from the electronic device in the three-dimensional environment and the first virtual reticle is presented at the first distance from the electronic device in the three-dimensional environment. In some examples, the method further comprises, while presenting the first virtual reticle, detecting a second surface, different from the first surface, targeted by the first virtual reticle, wherein the second surface is a second distance, different from the first distance, from the electronic device. In some examples, the method further comprises, in response to detecting the second surface targeted by the first virtual reticle, changing the presentation of the first virtual reticle from the first distance to the second distance from the electronic device in the three-dimensional environment.

Additionally, or alternatively, in some examples, the method further comprises, in accordance with a determination that the difference between the first distance and the second distance is a first amount, applying a first filter to the presentation of the first virtual reticle while changing the presentation of the first virtual reticle from the first distance to the second distance from the electronic device in the three-dimensional environment. In some examples, the method further comprises, in accordance with a determination that the difference between the first distance and the second distance is a second amount, different from the first amount, applying a second filter, different from the first filter, to the presentation of the first virtual reticle while changing the presentation of the first virtual reticle from the first distance to the second distance from the electronic device in the three-dimensional environment.

Additionally, or alternatively, in some examples, the method further comprises, while presenting the first virtual reticle in the three-dimensional environment, presenting, via the display, a preview of the virtual representation of the at least the portion of the one or more physical objects, and in accordance with a determination that one or more second criteria are satisfied, updating the preview while concurrently presenting an animation, the animation progressing through respective portions of the preview while the respective portions of the preview are updated.

Additionally, or alternatively, in some examples, the method further comprises, while presenting the first virtual reticle in the three-dimensional environment, presenting, via the display, a preview of the virtual representation of a first portion of the one or more physical objects, and in accordance with a determination that one or more second criteria are satisfied, the one or more second criteria including a criterion that the first virtual reticle has targeted a respective region of the three-dimensional environment for more than a threshold period of time, updating the preview to represent a second portion, larger than the first portion, of the one or more physical objects including the respective region of the three-dimensional environment.

Additionally, or alternatively, in some examples, the preview of the virtual representation of the first portion of the one or more physical objects is displayed on a virtual object in the three-dimensional environment, and updating the preview to represent the second portion of the one or more physical objects includes changing a scale of the preview while maintaining a scale of the virtual object.

Additionally, or alternatively, in some examples, the one or more first criteria include a criterion that is satisfied when the electronic device is in a first mode for initiating a first type of capture process. In some examples, the method further comprises, in response to initiating the capture process, in accordance with a determination that one or more second criteria are satisfied, the one or more second criteria including a criterion that is satisfied when the electronic device is in a second mode for initiating a second type of capture process, different from the first type of capture process, presenting, via the display, a second virtual reticle, different from the first virtual reticle, in the three-dimensional environment at a respective orientation.

Additionally, or alternatively, in some examples, the method further comprises, after initiating the capture process, presenting, via the display, a second view, different from the first view, of the three-dimensional environment. In some examples, the method further comprises, in accordance with a determination that the capture process is the first type of capture process, changing the presentation of the first virtual reticle in the three-dimensional environment from the first orientation to a second orientation, different from the first orientation, the second orientation corresponding to a second feature of a second surface targeted by the first virtual reticle. In some examples, the method further comprises, in accordance with a determination that the capture process is the second type of capture process, maintaining display of the second virtual reticle at the respective orientation.

Additionally, or alternatively, in some examples, the method further comprises, after ceasing the capture process, presenting, via the display, the virtual representation of the at least the portion of the one or more physical objects, and in accordance with a determination that one or more second criteria are satisfied, presenting, via the display, the virtual representation of the at least the portion of the one or more physical objects with one or more indications corresponding to one or more locations of the electronic device corresponding to images captured during the capture process.

Some examples of the disclosure are directed to an electronic device, comprising: one or more processors, memory, and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the invention and its practical applications, to thereby enable others skilled in the art to best use the invention and various described examples with various modifications as are suited to the particular use contemplated.

1. A method, comprising:
at an electronic device in communication with a display and one or more input devices:
while presenting, via the display, a first view of a three-dimensional environment including one or more physical objects, initiating a capture process for generating a virtual representation of at least a portion of the one or more physical objects; and
in response to initiating the capture process, in accordance with a determination that one or more first criteria are satisfied, presenting, via the display, a first virtual reticle in the three-dimensional environment, wherein the first virtual reticle is presented at a first orientation corresponding to a first feature of a first surface targeted by the first virtual reticle.

2. The method of claim 1, further comprising:
while presenting, via the display, a second view, different from the first view, of the three-dimensional environment, presenting, via the display, the first virtual reticle in the three-dimensional environment at a second orientation, different from the first orientation, corresponding to a second feature of a second surface targeted by the first virtual reticle.

3. The method of claim 1, wherein presenting the first virtual reticle in the three-dimensional environment at the first orientation includes presenting the first virtual reticle at a first depth in the three-dimensional environment corresponding to a depth of the first surface.

4. The method of claim 1, wherein the one or more first criteria include a criterion that is satisfied when a respective surface of the one or more physical objects that is targeted by the first virtual reticle is within a range of distances from the electronic device.

5. The method of claim 4, further comprising:
while presenting the first virtual reticle in the three-dimensional environment, wherein the three-dimensional environment is presented from a second view, different from the first view, detecting, via the one or more input devices, a second surface, different from the first surface, targeted by the first virtual reticle; and
in response to detecting the second surface targeted by the first virtual reticle:
in accordance with a determination that the second surface targeted by the first virtual reticle is within the range of distances from the electronic device, presenting, via the display, the first virtual reticle at a second orientation, different from the first orientation, corresponding to a second feature of the second surface targeted by the first virtual reticle; and
in accordance with a determination that the second surface targeted by the first virtual reticle is outside of the range of distances from the electronic device, ceasing presentation of the first virtual reticle in the three-dimensional environment.

6. The method of claim 1, wherein the first surface is a first distance from the electronic device in the three-dimensional environment and the first virtual reticle is presented at the first distance from the electronic device in the three-dimensional environment, the method further comprising:
while presenting the first virtual reticle, detecting a second surface, different from the first surface, targeted by the first virtual reticle, wherein the second surface is a second distance, different from the first distance, from the electronic device; and
in response to detecting the second surface targeted by the first virtual reticle, changing a presentation of the first virtual reticle from the first distance to the second distance from the electronic device in the three-dimensional environment.

7. The method of claim 1, further comprising:
while presenting the first virtual reticle in the three-dimensional environment, presenting, via the display, a preview of the virtual representation of the at least the portion of the one or more physical objects; and
in accordance with a determination that one or more second criteria are satisfied, updating the preview while concurrently presenting an animation, the animation progressing through respective portions of the preview while the respective portions of the preview are updated.

8. An electronic device, comprising:
one or more processors;
memory; and
one or more programs, wherein the one or more programs are stored in the memory and configured to be executed by the one or more processors, the one or more programs including instructions for:
while presenting, via a display of the electronic device, a first view of a three-dimensional environment including one or more physical objects, initiating a capture process for generating a virtual representation of at least a portion of the one or more physical objects; and
in response to initiating the capture process, in accordance with a determination that one or more first criteria are satisfied, presenting, via the display, a first virtual reticle in the three-dimensional environment, wherein the first virtual reticle is presented at a first orientation corresponding to a first feature of a first surface targeted by the first virtual reticle.

9. The electronic device of claim 8, wherein the one or more programs further include instructions for:
while presenting, via the display, a second view, different from the first view, of the three-dimensional environment, presenting, via the display, the first virtual reticle in the three-dimensional environment at a second orientation, different from the first orientation, corresponding to a second feature of a second surface targeted by the first virtual reticle.

10. The electronic device of claim 8, wherein presenting the first virtual reticle in the three-dimensional environment at the first orientation includes presenting the first virtual reticle at a first depth in the three-dimensional environment corresponding to a depth of the first surface.

11. The electronic device of claim 8, wherein the one or more first criteria include a criterion that is satisfied when a respective surface of the one or more physical objects that is targeted by the first virtual reticle is within a range of distances from the electronic device.

12. The electronic device of claim 11, the one or more programs further including instructions for:
while presenting the first virtual reticle in the three-dimensional environment, wherein the three-dimensional environment is presented from a second view, different from the first view, detecting, via one or more input devices in communication with the electronic device, a second surface, different from the first surface, targeted by the first virtual reticle; and
in response to detecting the second surface targeted by the first virtual reticle:
in accordance with a determination that the second surface targeted by the first virtual reticle is within the range of distances from the electronic device, presenting, via the display, the first virtual reticle at a second orientation, different from the first orientation, corresponding to a second feature of the second surface targeted by the first virtual reticle; and
in accordance with a determination that the second surface targeted by the first virtual reticle is outside of the range of distances from the electronic device, ceasing presentation of the first virtual reticle in the three-dimensional environment.

13. The electronic device of claim 8, wherein:
the first surface is a first distance from the electronic device in the three-dimensional environment and the first virtual reticle is presented at the first distance from the electronic device in the three-dimensional environment, and
the one or more programs further include instructions for:
while presenting the first virtual reticle, detecting a second surface, different from the first surface, targeted by the first virtual reticle, wherein the second surface is a second distance, different from the first distance, from the electronic device; and
in response to detecting the second surface targeted by the first virtual reticle, changing a presentation of the first virtual reticle from the first distance to the second distance from the electronic device in the three-dimensional environment.

14. The electronic device of claim 8, the one or more programs further including instructions for:
while presenting the first virtual reticle in the three-dimensional environment, presenting, via the display, a preview of the virtual representation of the at least the portion of the one or more physical objects; and
in accordance with a determination that one or more second criteria are satisfied, updating the preview while concurrently presenting an animation, the animation progressing through respective portions of the preview while the respective portions of the preview are updated.

15. A non-transitory computer readable storage medium storing one or more programs, the one or more programs comprising instructions, which when executed by one or more processors of an electronic device, cause the electronic device to:
while presenting, via a display of the electronic device, a first view of a three-dimensional environment including one or more physical objects, initiate a capture process for generating a virtual representation of at least a portion of the one or more physical objects; and
in response to initiating the capture process, in accordance with a determination that one or more first criteria are satisfied, present, via the display, a first virtual reticle in the three-dimensional environment, wherein the first virtual reticle is presented at a first orientation corresponding to a first feature of a first surface targeted by the first virtual reticle.

16. The non-transitory computer readable storage medium of claim 15, further comprising instructions, which when executed by one or more processors of an electronic device, cause the electronic device to:
while presenting, via the display, a second view, different from the first view, of the three-dimensional environment, present, via the display, the first virtual reticle in the three-dimensional environment at a second orientation, different from the first orientation, corresponding to a second feature of a second surface targeted by the first virtual reticle.

17. The non-transitory computer readable storage medium of claim 15, wherein presenting the first virtual reticle in the three-dimensional environment at the first orientation includes presenting the first virtual reticle at a first depth in the three-dimensional environment corresponding to a depth of the first surface.

18. The non-transitory computer readable storage medium of claim 15, wherein the one or more first criteria include a criterion that is satisfied when a respective surface of the one or more physical objects that is targeted by the first virtual reticle is within a range of distances from the electronic device.

19. The non-transitory computer readable storage medium of claim 15, wherein:
the first surface is a first distance from the electronic device in the three-dimensional environment and the first virtual reticle is presented at the first distance from the electronic device in the three-dimensional environment, and
the non-transitory computer readable storage medium further comprises instructions, which when executed by one or more processors of an electronic device, cause the electronic device to:
while presenting the first virtual reticle, detect a second surface, different from the first surface, targeted by the first virtual reticle, wherein the second surface is a second distance, different from the first distance, from the electronic device; and
in response to detecting the second surface targeted by the first virtual reticle, change a presentation of the first virtual reticle from the first distance to the second distance from the electronic device in the three-dimensional environment.

20. The non-transitory computer readable storage medium of claim 15, further comprising instructions, which when executed by one or more processors of an electronic device, cause the electronic device to:
while presenting the first virtual reticle in the three-dimensional environment, present, via the display, a preview of the virtual representation of the at least the portion of the one or more physical objects; and
in accordance with a determination that one or more second criteria are satisfied, update the preview while concurrently presenting an animation, the animation progressing through respective portions of the preview while the respective portions of the preview are updated.
